(19) United States
(12) Patent Application Publication
(10) Pub. No.: US 2014/0315012 A1
(43) Pub. Date: Oct. 23, 2014

(54) NANO-GRAPHENE SHEET-FILLED POLYIMIDE COMPOSITES AND METHODS OF MAKING SAME

(71) Applicant: University of Cincinnati, Cincinnati, OH (US)

(72) Inventors: Jude Iroh, Mason, OH (US); Jimmy Longun, Cincinnati, OH (US)

(21) Appl. No.: 14/356,749

(22) PCT Filed: Nov. 7, 2012
(86) PCT No.: PCT/US2012/063851

§ 371 Date: May 7, 2014

Related U.S. Application Data
(60) Provisional application No. 61/556,429, filed on Nov. 7, 2011.
(60) Provisional application No. 61/714,104, filed on Oct. 15, 2012.

(51) Int. Cl. H01B 1/24; H01B 13/00

(52) U.S. Cl. CPC H01B 1/24; H01B 13/0026
USPC 428/323; 252/511; 427/122

(57) ABSTRACT

A composite material including a dispersion of nano-graphene sheet particles in a polyimide matrix and a method making films of the composite material are provided. The method includes forming a solution of nano-graphene sheet particles and poly(amic acid), casting the solution on a substrate to form a film, and imidizing the film. The films of the composite materials are suitable for use in batteries, capacitors, fuel cell components, solar cell components, display screens, and the like.

### CROSS-REFERENCE TO RELATED APPLICATIONS

Pursuant to 37 C.F.R. §1.78, this application claims the benefit of and priority to prior filed co-pending PCT Patent Application PCT/US2012/063851, which was filed on Nov. 7, 2012, which in turn claimed the benefit of and priority to U.S. Provisional Patent Application No. 61/556,429, filed Nov. 7, 2011, and U.S. Provisional Patent Application No. 61/714,104 filed Oct. 15, 2012, the disclosures of which are incorporated by reference in their entirety.

### GOVERNMENT GRANT SUPPORT CLAUSE

This invention was made with government support under grant #CMMI-0758656 awarded by the National Science Foundation. The government has certain rights in the invention.

### FIELD OF THE DISCLOSURE

The present invention relates to composite materials that include graphene and polyimides. In particular, the present invention relates to composite materials that include nano-graphene sheet particles and polyimide polymers.

### BACKGROUND OF THE DISCLOSURE

Transparent conducting oxides are commonly referred to as a group of transparent conductors. These transparent conducting oxides are generally defined by one or both of their conductivity and transparency. These conductors have been widely used in a variety of applications including, anti-static coatings, touch screens, flexible displays, electroluminescent devices, electrochromic systems, solar cells, and energy efficient windows, to name a few. The individual applications normally require a certain conductivity and transparency for the materials. Sometimes more stringent requirements may be imposed to ensure the structural and functional integrity of the transparent conducting oxides when the application is deployed in an extreme environment.

Technology associated with the preparation of durable transparent conductors has been key in the development of anti-static coatings, touch screens, flexible displays, and the like. All of these applications are dependent upon excellent performance in the electrical, optical, and mechanical properties of the transparent conductor.

Indium-tin-oxide (ITO) thin films are one of the most common transparent conductors and have been prepared on polymeric substrates such as polyesters or polycarbonates by using sputtering, chemical vapor deposition (CVD), electron beam evaporation, reactive deposition, and pulsed laser deposition. Such approaches usually require high temperature annealing or ultraviolet laser processing, which can damage the polymeric substrates and induce structural and color change, especially if the polymers are aromatics-based systems. In addition, compressive internal stresses can be developed and can easily initiate tensile cracking on ITO thin films.

Polyimide and its composites have been of interest for replacing ITO for various applications due to their favorable properties, which include thermal-oxidative stability, solvent resistance, superior tensile modulus, and excellent environmental stability. For example, polyimide has been used extensively in the fabrication of aircraft structures, microelectronic devices and circuit boards, to mention a few. However, due to the insulating nature of polyimide, electrostatic charges can accumulate on the surface of materials comprising polyimides thereby leading to localized heating and subsequent degradation of the material. The accumulation of charges can also cause sparks especially when polyimide is used in aircraft structures.

Previous researchers, in an attempt to reduce the accumulation of electrostatic charges, have improved the surface resistivity of polyimide in the range of 10⁶-10¹⁰ Ω/cm² by adding single wall carbon nanotubes (SWNT). Other researchers have also studied the surface resistivity of polyimide/carbon black composite. However, these polyimide composite materials have not demonstrated the requisite physical properties, such the electrical, optical, and mechanical properties, necessary for replacing traditional transparent conducting materials.

### SUMMARY

According to one embodiment of the present invention, a composite material is provided that includes a dispersion of nano-graphene sheet (NGS) particles in a polyimide (PI) matrix.

According to another embodiment of the present invention, a method of forming a nano-graphene sheet filled polyimide (NGS/PI) film is provided. The method includes 1) forming a dispersion of nano-graphene sheet particles and poly(amic acid) (PAA); 2) casting the dispersion on a substrate to form a film; and 3) imidizing the film. According to yet another embodiment, a nano-graphene sheet particle filled polyimide film is provided by the foregoing method.

These and other embodiments of the invention will be readily apparent from the following figures and detailed description of the present invention.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a UV-Vis absorption spectra of NGS/PAA solutions, in accordance with an embodiment of the invention;

FIGS. 2A-2F are photographic images showing (2A) NGS powder; (2B) neat poly(amic acid); (2C) N-methylpyrrolidinone (NMP); (2D) 5 mg/L NGS/NMP; (2E) 1.18% NGS/PAA; and (2F) 6.12% NGS/PAA, in accordance with embodiments of the invention;

FIGS. 2G-2J are photographic images of NGS/PI films, in accordance with embodiments of the invention;

FIG. 3A is absorption spectra of NGS/NMP solutions, in accordance with embodiments of the invention;

FIG. 3B is absorption spectra of NGS/PAA solutions in NMP, in accordance with embodiments of the invention;

FIG. 4A is a graph showing linear relationship between UV-Vis absorbance at a wavelength of 500 nm and the concentration of NGS in NMP, in accordance with embodiments of the invention;

FIG. 4B is a graph showing linear relationship between UV-Vis absorbance at a wavelength of 500 nm and the concentration of NGS in PAA, in accordance with embodiments of the invention;

FIG. 5 is a solid-state spectra showing optical transmittance of (a) neat-PI; (b) 0.29 vol % NGS/PI; (c) 1.1.8 vol % NGS/PI; and (d) 6.12 vol % NGS/PI composite films of about 400 nm thickness, in accordance with embodiments of the invention;

FIG. 6 is a solid-state spectra showing optical transmittance of (a) neat-PI; (b) ITO; and (c) 6.12 vol % NGS/PI composite films of about 400 nm thickness, in accordance with embodiments of the invention;

FIGS. 7A and 7B are graphs showing (A) onset (induction) wavelength (λ) and (B) optical transmittance at 550 nm, 800 nm, and 1000 nm for ITO and NGS/PI composite films, in accordance with embodiments of the invention;

FIG. 8A is a chart showing voltage (V) as a function of current (A) for NGS/PI composite films, in accordance with an embodiment of the invention;

FIG. 8B is a chart showing conductivity (S/cm) as a function of graphene weight percent (wt %) for NGS/PI composite films, in accordance with an embodiment of the invention;

FIG. 9A is a chart showing surface conductivity of NGS/PI composite as a function of NGS vol % from which the percolation threshold Ø_{c} can be estimated, in accordance with an embodiment of the invention;

FIG. 9B is a chart showing conductivity as a function of Ø−Ø_{c} from which the critical exponent, t can be estimated, showing Ø_{c}˜0.2 vol % and t=4.80±0.52, in accordance with an embodiment of the invention;

FIG. 10 is a chart showing the log of sheet conductivity, σₛ versus concentration Ø^{-1/3} used to demonstrate quantum electron tunneling behavior in NGS/PI composite, in accordance with an embodiment of the invention;

FIG. 11 is Raman spectra of (a) Neat-PI and NGS/PI composites containing (b) 1.18 vol %, (c) 6.12 vol %, (d) 28.08 vol %, and (e) 36.96 vol % NGS, in accordance with embodiments of the invention;

FIG. 12A is a WAXD thermogram of (a) Neat-PI and (b) graphene powder;

FIG. 12B is a WAXD thermogram of NGS/PI composite films (a) 0.29 vol % NGS/PI (400 nm), (b) 6.12 vol % NGS/PI (400 nm), (c) 0.29 vol % NGS/PI (100 micron), (d) 6.12 vol % NGS/PI (100 micron), in accordance with embodiments of the invention;

FIG. 13A is a TGA thermogram showing analysis of (a) Neat-PI and NGS/PI composites containing (b) 1.18 vol %, (c) 6.12 vol %, and (d) 36.96 vol % NGS, in accordance with embodiments of the invention;

FIG. 13B is derivative plots of weight retention versus NGS volume fraction at 200° C., 400° C., and 700° C., in accordance with embodiments of the invention;

FIGS. 14A and 14B show SEM cross-sectional images of NGS/PI composite containing (a) 6.12 vol % and (b) 28.08 vol % NGS, in accordance with embodiments of the invention;

FIGS. 14C and 14D are atomic force microscope (AFM) height profiles of NGS/PI composite films containing (C) 1.18 vol % and (D) 6.12 vol % NGS, in accordance with embodiments of the invention;

FIGS. 14E and 14F are height profiles of cross-sectional areas of the NGS/PI shown in FIGS. 14C and 14D, respectively, in accordance with embodiments of the invention;

FIGS. 15A and 15B are graphs showing (A) storage modulus and (B) tan δ of (a) neat-PI and PI containing (b) 0.29, (c) 1.18, (d) 6.12, and (e) 28.08 vol % NGS, in accordance with embodiments of the invention;

FIGS. 16A and 16B are graphs showing tan δ (alpha-transition peak) area and glass transition temperature (T_{g}) as a function of NGS volume percent at low (>1.18 vol. %) and high (≧28.08 vol. %) NGS concentration, in accordance with embodiments of the invention;

FIGS. 17A and 17B are graphs showing (A) storage modulus (E′), and (B) rubbery plateau modulus (E^{r}) of NGS/PI composite as a function of NGS volume percent at low (≧1.18 vol. %) and high (≧28.08 vol. %) NGS concentration, in accordance with embodiments of the invention;

FIG. 18 is a graph showing storage modulus enhancement E′_{δ}, (E^{c}_{δ}/E^{m}_{δ}) for NGS/PI composite as a function of NGS volume percent, in accordance with embodiments of the invention;

FIG. 19 is a graph showing modulus enhancement of NGS/PI composites in the rubbery plateau region at low (≧1.18 vol. %) and high (≧28.08 vol. %) NGS concentration, in accordance with embodiments of the invention; and

FIG. 20 is a graph showing modulus enhancement of NGS/PI composites in the glassy region at low (≧1.18 vol. %) and high (≧28.08 vol. %) NGS concentration, in accordance with embodiments of the invention.

### DETAILED DESCRIPTION OF EMBODIMENTS OF THE INVENTION

Unless otherwise explained, all technical and scientific terms used herein have the same meaning as commonly understood by one of ordinary skill in the art to which this disclosure belongs. In case of conflict, the present specification, including explanations of terms, will control. The singular terms “a,” “an,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together.

As used herein, the term “dispersion” refers to a composition in which particles are dispersed in a continuous phase of a liquid or a solid. In accordance with one embodiment, the dispersed particles can precipitate or settle from a liquid phase, but may remain suspended with sufficient mixing. In accordance with another embodiment, the dispersed particles can remain suspended in the continuous phase of the liquid, and thereby resemble a homogenous solution. Accordingly, the term “dispersion” encompasses both of these embodiments.

Aspects of the invention are directed to films of composite materials comprising nano-graphene sheet particles dispersed in a polyimide matrix. As used herein, the term “graphene sheets” means an allotrope of carbon wherein layered sp² hybridized carbon atoms are arranged in a two-dimensional lattice structure. It should be appreciated that the term “graphene sheets” does not encompass other allotropes of carbon, such as single-walled carbon nano-tubes (SWCNT) and multi-walled carbon nano-tubes (MWCNT). However, in accordance with one embodiment, the composite materials of the present invention may further comprise other allotropes of carbon, such as SWCNT and/or MWCNT. In accordance with another embodiment, the composite materials may be substantially free of other allotropes of carbon. As used herein, “substantially free” means that the specified component has not been intentionally added, but does not preclude the adventitious presence of the component as a contaminant or by-product from the nano-graphene sheet particles synthesis and/or preparation.

In accordance with one aspect of the present invention, the nano-graphene sheet particles are nanomaterials, which are characterized as having at least one dimension smaller than about one tenth of a micrometer (i.e., less than about 100 nm). It should be appreciated that individual graphene sheets are comprised of a single atomic layer of carbon, and the individual graphene sheets can be stacked to form the nano-graphene sheet particles. These particles are commonly characterized by two dimensions, width and length, with width being the smaller dimension of the two. For example, the nano-graphene sheet particles used to prepare the composites of the present invention can have an average width less than about 100 nm. In one embodiment, the nano-graphene sheet particles have an average width in a range from about 50 nm to about 100 nm, about 10 nm to about 20 nm, or less than 5 nm, for example. According to another aspect, the nano-graphene sheet particles can have an average length greater than 100 nm. According to another aspect, the nanographene sheet particles can have an average length that is less than about 20 microns. Accordingly, the nano-graphene sheet particles can have an average length in a range from about less than 20 micron to about greater than 100 nm. For example, the average length of the nano-graphene sheet particle can be about 14 microns, or about 10 microns. Exemplary nano-graphene sheet particles suitable for use in the present invention are commercially available from Angstrom Materials, Inc. (Dayton, Ohio). For example, the nano-graphene sheet particles can have an average width of 50 nm to 100 nm, and have an average length of about 7 microns. As discussed in more detail below, during the process of making the composite materials, the nano-graphene sheet particles are subjected to conditions that reduce the particle size of the starting nano-graphene sheet particles.

The nano-graphene sheet particles may be present in the composite material in an amount greater than about 0.1 weight percent (wt %). For example, the nano-graphene sheet particles may be present in the composition in an amount in a range from about 0.1 wt % to about 150 wt %, from about 0.1 wt % to about 100 wt %, from about 0.1 wt % to about 60 wt %, from about 1 wt % to about 45 wt %. Exemplary composite materials may comprise nano-graphene sheet particles in an amount of about 0.3 wt %, about 0.6 wt %, about 1.2 wt %, about 6.1 wt %, about 12.8 wt %, about 22.1 wt %, about 28.1 wt %, about 40 wt %, or about 46.8 wt %, and ranges in between. All weight percents are based on the weight of the polyimide component of the composite material. It should be further appreciated that the weight percentage of the nano-graphene sheet particles in the composite may be converted to volume percentages using density of the nano-graphene sheet particles, density of the NGS/PI composite, and weight fraction of the nano-graphene sheet particles in the composite by the following relationship:

V_{NGS}=(ρ_{NGS/PI}/ρ_{NGS})×W_{NGS},

where V_{NGS} is the volume fraction of nano-graphene sheets, ρ_{NGS/PI} is the density of NGS/PI composite, ρ_{NGS} is the density of nano-graphene sheet particles, and W_{NGS} is the weight fraction of nano-graphene sheets particles. For example, the weight of graphene and polyimide can be measured; the density of the nano-graphene sheet particles and polyimide can be obtained from literature or measured; the weight and volume of NGS/PI composite can be measured; and therefore, the density of composite can be calculated.

In accordance with another aspect of the present invention, the composite material comprises a polyimide matrix, wherein the nano-graphene sheet particles are dispersed. According to one embodiment of the present invention, the polyimide matrix is derived from a reaction product of a diamine compound and a dianhydride compound. Exemplary diamine compounds include, but are not limited to, aromatic diamine compounds. For example, the diamine compound may be an aromatic diamine compound, such as 4,4′-oxydianiline (ODA). Exemplary dianhydride compounds include, but are not limited to, pyromellitic dianhydride (PMDA).

Polyimides for use in the present invention can be synthesized in a two-step process, where the first step involves a polymerization reaction between the diamine compound and the dianhydride compound in the presence nano-graphene sheet (NGS) particles in a polar, aprotic solvent leading to the formation of a corresponding poly(amic acid) by ring-opening polyaddition. In one embodiment, the molecular weight range of the poly(amic acid) is in a range from about 1,000 g/mole to about 10,000 g/mol. The second step involves the cyclodehydration of the poly(amic acid) to its corresponding polyimide by thermal or chemical methods. A simplified example of this two-step process without the NGS particles is shown in Scheme 1 using ODA as an exemplary diamine compound and PMDA as an exemplary dianhydride compound.

SCHEME 1: Two Step Synthesis of Polyimides

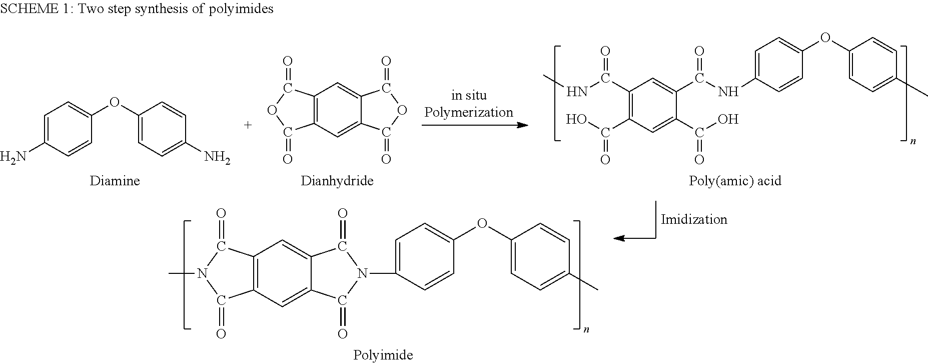

In accordance with another embodiment of the present invention, the method of forming a nano-graphene sheet particle filled polyimide film, comprises 1) forming a dispersion of nano-graphene sheet particles and poly(amic acid); 2) casting the dispersion on a substrate to form a film; and 3) imidizing the film. According to one aspect of the method, the poly(amic acid) is prepared in situ, meaning in the presence of dispersed nano-graphene sheet particles.

Dispersions of the nano-graphene sheet particles can be prepared using polar, aprotic solvents that do not substantially interfere with the poly(amic acid) synthesis. Suitable polar, aprotic solvents, include but are not limited to, tetrahydrofuran (THF), dimethyl formamide (DMF), dimethylacetamide (DMAc), N-methylpyrrolidinone (NMP), and dimethylsulfoxide (DMSO). In one example, the polar, aprotic solvent is N-methylpyrrolidinone.

The nano-graphene sheet particles may be added to a volume of the polar, aprotic solvent in gradual amounts while mechanically stirring the mixture and/or under ultrasonic agitation to form a dispersion of nano-graphene sheet particles in the solvent, and then the desired amount of the diamine compound can be subsequently added. Alternatively, a solution of the diamine compound may formed prior to adding the nano-graphene sheet particles. In either case, the resultant combination of ingredients are mixed for a sufficient time so as to permit the solvent and/or diamine compound to intercalate into the layers of the nano-graphene sheets to facilitate separating layers of graphene sheets thereby reducing the number of sheets in a given nano-graphene sheet particle. Without being bound by any particular theory, it is postulated that polar, aprotic solvents such as NMP can exfloliate nano-graphene sheet particles and also form stable dispersions of nano-graphene sheet particles and/or poly(amic acid). Mechanical shear stress and/or ultrasonic mixing can also facilitate this process. Advantageously, both mechanical shear stress and ultrasonic mixing of the dispersion of the nano-graphene sheet particles in the polar solvent are used. According to one embodiment, nano-graphene sheet particles having an average width in a range from about 50 nm to about 100 nm dispersed in NMP are mixed under shearing and ultrasonic conditions to thereby form the dispersion of nano-graphene sheet particles prior to the in situ polymerization step, described below.

Next, a dianhydride compound is added to the dispersed nano-graphene mixture thereby affecting an in situ polymerization to form the solution of nano-graphene sheet particles and poly(amic acid). In accordance with aspects of the present invention, the dianhydride compound can be added to the dispersed nano-graphene mixture while maintaining a reaction mixture temperature in a range from about −10° C. to about 60° C. For example, the reaction mixture temperature can be about −10° C., about −5° C., about 0° C., about 5° C., about 10° C., about 15° C., about 20° C., about 25° C., about 30° C., about 35° C., about 40° C., about 45° C., about 50° C., about 55° C., about 60° C., or within ranges encompassed by combinations of the recited temperatures. In one example, the in situ poly(amic acid) synthesis step is conducted at about 10° C.

Solution casting of the solution of nano-graphene sheet particles and poly(amic acid) to form the films can be conducted according to methods commonly employed by skilled artisans. For example, the solution of nano-graphene sheets and poly(amic acid) can be applied (e.g., solution casting, or spin casting) to a substrate, e.g., a glass substrate, and then subjected to the imidization conditions. Solution casting can be done by solution drop method where the solution of nano-graphene sheet particles and poly(amic acid) is applied to the desired substrate (e.g., glass, silicone or Teflon plate) dropwise until the desired dimensions are reached. Alternatively, the solution can be spin coated onto the desired substrate. The spinning speed and concentration of solution can be varied in order to vary size (e.g., thickness) of the film. In either case, the film of nano-graphene sheet particles and poly(amic acid) is then thermally imidized to yield the cured nano-graphene sheet particle filled polyimide composite film.

The thickness of the film can be varied depending upon the intended use. According to one embodiment, the film thickness can be in a range from 100 nm to about 50 microns.

According to one aspect of the invention, the method for imidizing the film may comprise one or more heating steps to provide the desired nano-graphene sheet particle filled polyimide films. According to one example, the film on the substrate may be heated at a first temperature in a range from about 90° C. to about 130° C. for a first duration, which is subsequently followed by heating the film at a second temperature in a range from about 130° C. to about 250° C. for a second duration. In one aspect, the film may be gradually and continuously heated over the entire range of the first temperature for the first duration. Alternatively, the film may be heated to one or more temperatures in a step-wise manner. The subsequent heating step may be similarly performed. According to one aspect, the first duration can be for about 10 minutes or more, and the second duration can be for about 5 minutes or more. The time spent at each heating step or stage may be varied to provide a reasonable time for systematic but gradual removal of solvents (e.g., NMP and water) to avoid stress build-up, shrinkage, and/or fracture of the film. The thickness and/or volume fraction of NGS can also affect the length of time at each stage. It should be appreciated that increasing the thickness of the film generally increases the time spent at each stage.

According to another aspect, imidizing the film may be conducted under a reduced pressure atmosphere, which facilitates elimination of the solvent and/or water from the film. Accordingly, in one example imidizing the film can be performed in a vacuum (i.e., less than atmospheric pressure) oven by first heating the film at a temperature of about 120° C. for about 2 hours, followed by heating to 200° C. for 1 hour, both being conducted at about 30 inHg vacuum.

Non-limiting examples, in accordance with various principles of the present invention, are described and discussed below.

Experimental:

The reagents used in this study include nano-graphene sheet (NGS) particles (98.48% purity) of 50 nm-100 nm in width and 7 microns in length were purchased from Angstron Materials, Inc. (Dayton, Ohio). Pyromellitic dianhydride (PMDA) (99% purity), 4,4 oxydianiline (ODA) and N-methyl-pyrrolidone (NMP) (99% purity) were purchased from Sigma-Aldrich Company and used without further purification.

Synthesis of Graphene/Poly(Amic Acid) Solution:

5.1608 g of 4,4′-oxydianiline (ODA) was added to around-bottom flask containing 100 mL of N-methyl-pyrrolidone (NMP) followed by stirring. 0.05418 g of Nano-graphene powder was added to the resultant solution in gradual amounts under vigorous mechanical stirring. After 8 hours of vigorous stirring, 5.6216 g of pyromellitic dianhydride (PMDA) was added to the mixture. Stirring was continued for another 12 h while the temperature was maintained at 10° C. Additional graphene/poly(amic)acid solutions were prepared using 0.1078 g, 0.2156 g, 1.078 g, and 4.621 g of nano-graphene powder, respectively.

Fabrication of Nano-Graphene Sheet Particles/Polyimide (NGS/PI) Composite Films:

Nano-graphene sheet particles/polyimide composite (NGS/PI) films were prepared by solution casting of the nano-graphene sheet particles/poly(amic acid) suspension onto a glass substrate followed by thermal imidization in a vacuum oven at 120° C. for 2 h, and then at 200° C. for 1 h.

Solution UV-Visible Spectroscopy

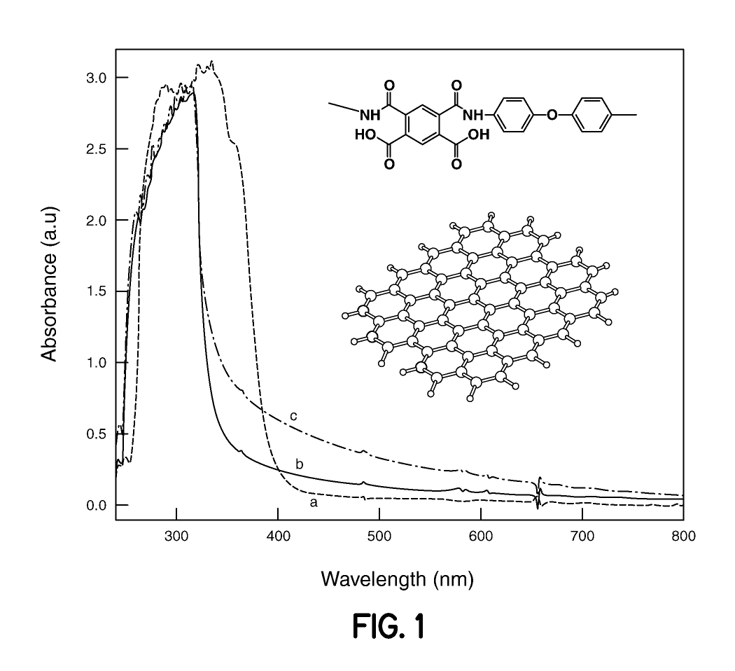

FIG. 1 shows the UV-Vis absorption spectra of NGS/PAA dispersion at NGS concentration of 0, 20 and 40 mg/L. High concentrations of NGS were used to allow visibility of graphene absorption patterns relative to the broad and intense absorption peak of poly(amic acid) between 260 and 390 nm. The UV-Vis spectra of poly(amic acid) solution (FIG. 1a) shows an intense absorbance peak between 260 and 390 nm, which is attributed to π-π* transition in the benzenoid structure. When nano-graphene sheets particles were dispersed in PAA solution, unique UV-Vis absorbance spectra showing increasing absorbance intensity between 250 and 800 nm are observed. The absorbance intensity between 250 and 800 nm increases with increasing concentration of graphene in NGS/PAA dispersion which is indicative of π-π* interaction between the graphitic structure in graphene and the benzenoid structure in PAA. Since PAA is strongly absorbing only between 260 and 390 nm, UV-Vis absorbance at higher wavelength (>400 nm) is attributed to graphene absorption only.

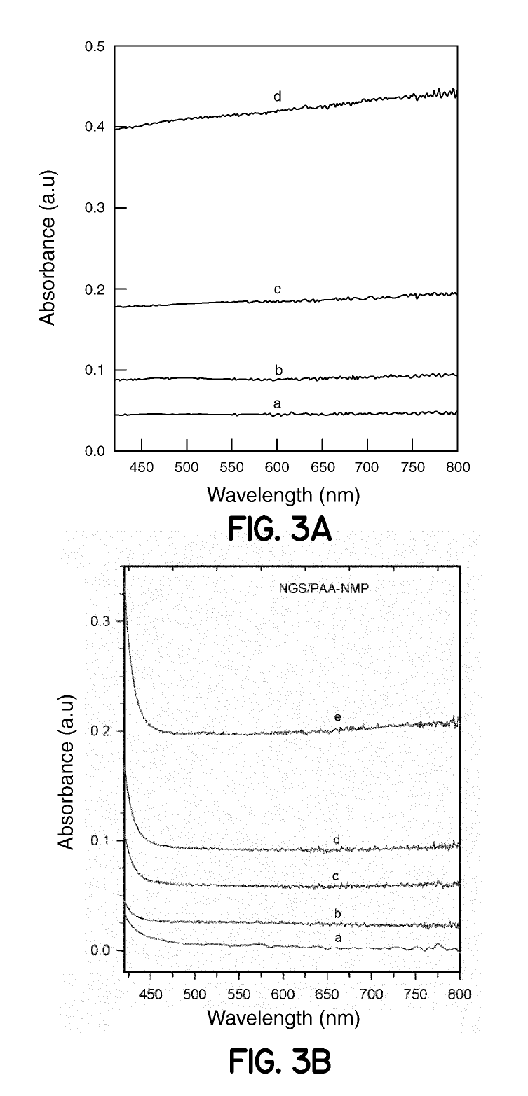

UV-Vis results of NGS/PAA also show that UV-Vis spectra of NGS/PAA are blued shifted by about 50 nm (0.47 eV) and 10 nm (0.1 eV) from 390 to 340 nm and from 360 to 350 nm, respectively, as shown in FIG. 1. The blue shift from 390 to 340 nm is believed to be due to the effect of graphene sheets on the UV-Vis absorption of PAA, in such as a way that ultraviolet light is shielded away from poly(amic), thereby reducing its effective absorption in the UV region. In FIG. 3A, a graphene absorption peak is observed at about 380 nm (3.27 eV) and previous UV-Vis studies of graphene dispersion in water have reported the presence of a graphene absorption peak at about 265 nm, which is attributed to the graphitic structure in graphene. The UV-Vis absorption of graphene at about 265 nm (4.69 eV) has been associated with the excitation of π-Plasmon in the graphitic structure. In this regard, the blue shift (0.1 eV) in UV-Vis absorption of NGS/PAA, is believed to be due the effect of the poly(amic acid) hydroxyl groups on the optical absorbance of graphene.

Dispersions of NGS in NMP and PAA Solutions

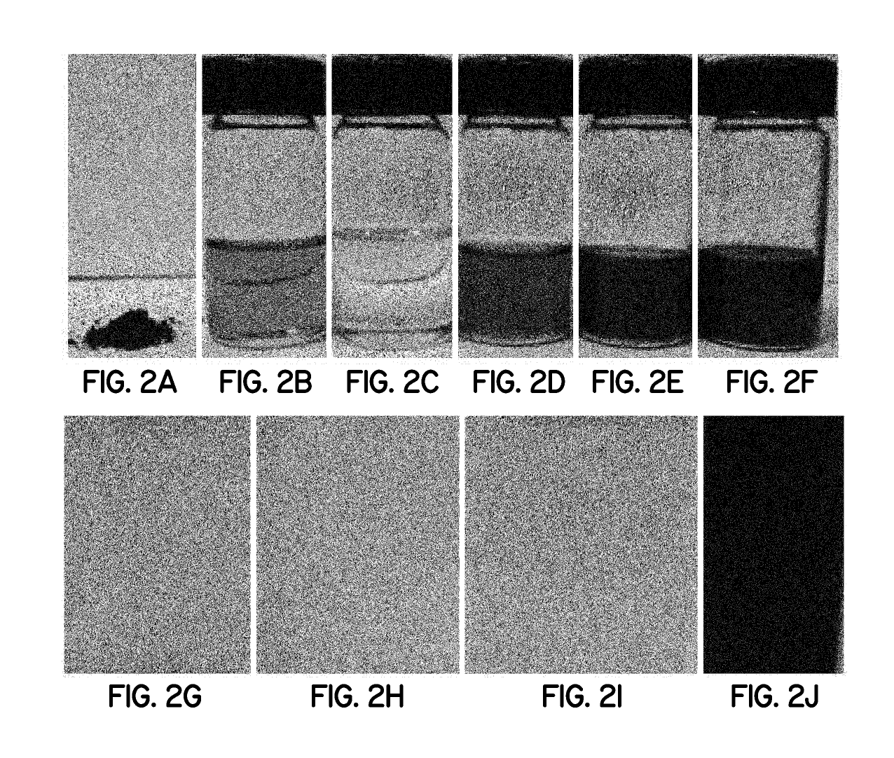

Dispersion of NGS in NMP solution was achieved via ultrasonication. The addition of NGS to NMP and PAA resulted in a uniform dispersion of NGS/NMP (FIG. 2D) and NGS/PAA (FIGS. 1E and 1F) without any visible aggregates. The effective dispersion of nano-graphene sheet particles in NMP and PAA solution was quantitatively evaluated and compared using absorbance measurement and the Beer-Lambert law. The concentration of nano-graphene sheet particles in NMP and PAA solution can be determined by using the Beer-Lambert law in Equation 1.

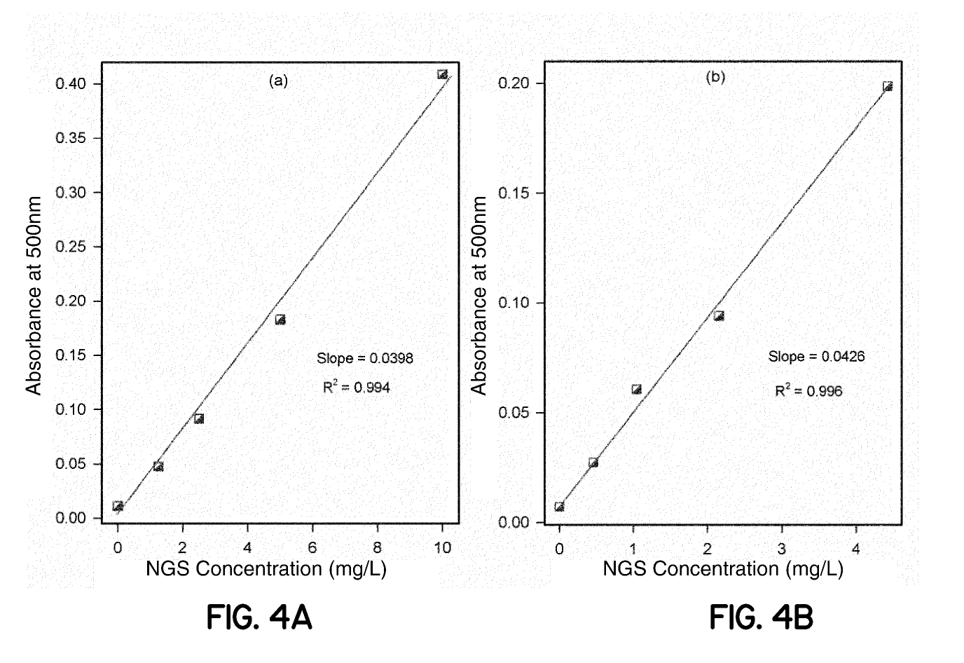

A=ε/c Equation (1)

where A is the absorbance at a particular wavelength, ε the extinction coefficient, l the optical path length (l=1 cm) and c is the nano-graphene sheet particles concentration. In order to obtain the value of ε, the absorbance spectra (FIG. 3) of very dilute and homogenously dispersed NGS/NMP and NGS/PAA dispersions were measured and the absorbance at 500 nm was plotted as a function of graphene concentration (FIGS. 4A and 4B, respectively). The values of slope, obtained using the linear-least squares fit method, were 0.0398 and 0.0426 for NGS/NMP and NGS/PAA solutions, respectively, corresponding to R² values greater than 0.99. From the slope of the linear squares fit, the extinction coefficient of grapheme in NMP and PAA solution was calculated to be 0.0398 and 0.0426 L mg⁻¹ cm⁻¹, respectively.

The effectiveness of NMP in dispersing nano-graphene sheet particles is attributed to the similarities between the surface energy of graphene and NMP, which is about 70 mJ/m² and 65-75 mJ/m² for NMP and graphite sheets, respectively. The higher extinction coefficients (ε) of graphene in PAA (0.0426 L mg⁻¹ cm⁻¹) compared to NMP (0.0398 L mg⁻¹ cm⁻¹) indicates better dispersion of nano-graphene sheet particles in PAA than NMP solution and is attributed to the strong affinity of the rigid highly aromatic backbone of PAA to interact with the highly conjugated graphene sheets via π-π* interaction, while the pendant COOH and OH groups offers solubility to graphene sheets and prevent them from reaggregation. Previous UV-Vis studies conducted on MWCNTs have shown that when the size of the MWCNTs agglomerates is comparable to the wavelength of light, the apparent absorption coefficient is independent of the size of the agglomerate and only dependent on the concentration of MWCNTs and that large and dense agglomerates of MWCNTs lead to a decrease in apparent absorption coefficient. The NGS used in exemplary embodiments of the present invention were 50-100 nm in size, compared to the wavelength (500 nm) of light at which the absorption coefficient (ε) of NGS in NMP and PAA was computed, and the variation in extinction coefficient of graphene in NMP (0.0398 L mg⁻¹ cm⁻¹) and PAA (0.0426 L mg⁻¹ cm⁻¹) is attributed to degree of dispersion.

Optical Transparency

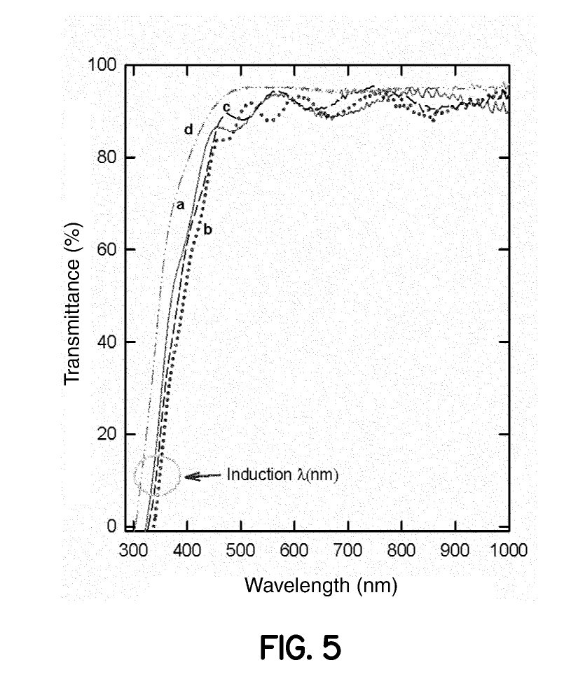

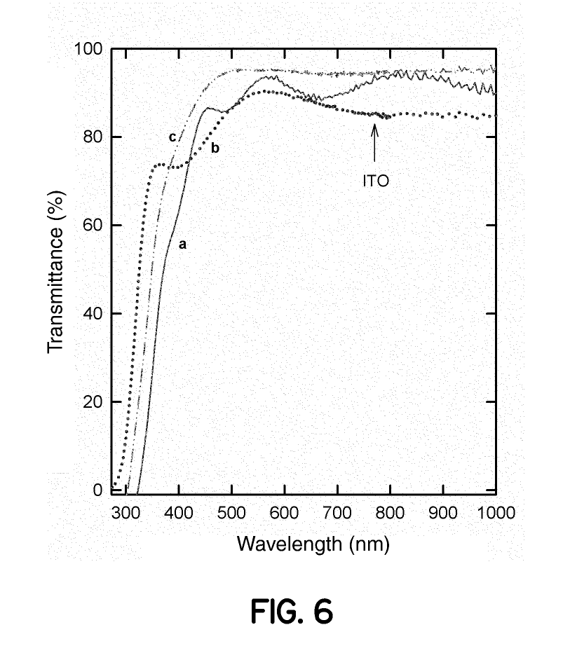

FIGS. 5-6 show the optical transmittance spectra of ITO, neat-PI and NGS/PI composite films containing nano-graphene sheet particles, plotted as a function of wavelength from 300 to 1000 nm. FIG. 5 shows the solid-state UV-Vis spectra of neat-PI (a) and NGS/PI (b-d) composite films in which films of thickness (400 nm) were studied. Optical transmittance of about 95.9%, 94%, and 95% in the visible and near infrared region were recorded for (b) 0.29 vol %, (c) 1.18 vol %, and (d) 6.12 vol % NGS/PI, respectively. The NGS/PI films were transparent up to 290 nm and improved transparency of 6.81 vol % NGS/PI over neat-PI is observed in the UV-region. This outstanding property of graphene in which transparency can be fine-tuned can enable NGS/PI composites to be used as saturable absorbers for high power lasers.

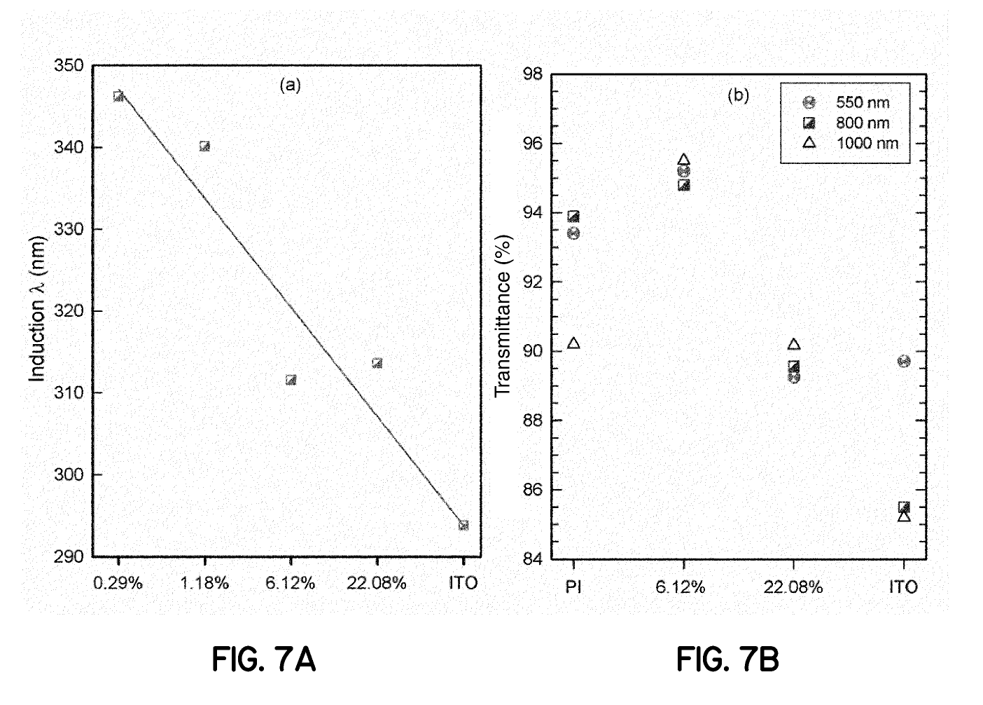

The optical transmittance of the NGS/PI composite at 550, 800 and 1000 nm as well as their induction (onset) wavelengths were plotted and compared to ITO as shown in FIG. 7. In the visible region from 400 to 800 nm, the average transmittance of NGS/PI composite varies from about 86% to 94.5% compared to the transmittance of ITO, which varies from about 73% to 89% in the same range (FIG. 7B). NGS/PI composites at 6.12% NGS volume percent show the highest optical absorbance in the visible range, corresponding to an optical transmittance of 78% to 95.8%. In comparison to their transmittance in the visible range, the transmittance in the ultraviolet region is low, at 280 to 400 nm. The sharp decrease in optical transmittance of NGS/PI composite in ultraviolet region is attributed to the absorbance of PI and to a smaller extent, graphene. The strong absorbance of ultraviolet light from 280 to 400 nm is due to π-π* transition in the benzenoid structure of PI as well as π-Plasmon in the graphitic structure of graphene. The plot of onset (induction) wavelength (FIG. 7A) of the NGS/PI composite as a function of NGS volume fraction shows a blue shift in transmittance wavelength with increasing NGS concentration. The blue shift in transmittance of NGS/PI composite in the ultraviolet region is attributed to the decreasing concentration of PI in the NGS/PI composite, which is the major component responsible for the strong absorbance of NGS/PI composite in the ultraviolet region.

Property Testing of NGS/PI Films

Conductivity

Surface conductivity of NGS/PI composite films was measured using four-point probe with equidistant probe spacing of 1.1 mm. Current of 0 to 10 mA was passed through the NGS/PI composite films using 6220 Precison Current Source and the induced voltage was measured using 2182A Nanovoltmeter. Surface resistance of the NGS/PI films was obtained from the slope of the I-V curve. All measurements were carried out at room temperature.

Optical Transparency

Solution and Solid-State UV-Vis spectroscopy was used to study the optical transparency of NGS/NMP solutions, NGS/PAA solutions, and the NGS/PI composite films. Transmittance and absorbance measurements were carried out from about 200 nm to about 1000 nm using a UV-Vis spectrophotometer, Single Cell Peltier Accessory, and U-3000 series spectrophotometer. Solution state measurements were performed using quartz glass cell of standard optical path length (1 cm) and transmittance measurements were performed relative to glass.

Thermal Studies

Thermal gravimetric analysis was used to study the thermal behavior and stability of NGS/PI composites. Tests were run at 10° C./min, from 25° C. to 800° C., using Netzsch STA409 PC Luxx model. All tests were performed in an inert atmosphere of argon which was purged at a rate of 20 ml/min.

Composite Morphological Characterization

Wide angle x-ray diffraction(WAXD) was used to study the dispersion and structure of the NGS/PI composite membranes. X-ray diffraction experiments were carried out by using a Cu—K radiation source at a wavelength of 1.54 Å. WAXD testing was carried out from diffraction on an angle of 2θ=0.5° to 2θ=30°. The cross-sectional morphology of the films was studied by using the Environmental Scanning Electron Microscopy, model FEI XL30 FEG ESEM. ESEM samples were prepared by immersion in liquid nitrogen and then fractured using a pair of tweezers to expose the cross-sectional area. A Polaron SC7640 sputter coater was used to coat the samples with Silver in order to improve their conductivity. The microstructure of the composites was studied using Atomic Force Microscopy (AFM). AFM measurements were conducted using Nanoscope Dimension™ 3100 Controller, Digital instruments operating in the tapping mode. Si-cantilevers manufactured by Nanoworld® were used with a force constant of 2.8 Nm and nominal resonance frequency of 75 KHz. The phase signal was set to zero at the resonance frequency of the tip. The tapping frequency was set to 10% lower than the resonance frequency. Drive amplitude was 360 mV and amplitude set-point was 1.4V.

Composite Dynamic Mechanical Analysis

Dynamic mechanical spectroscopy (DMS) was used to study the viscoelastic property of the composite films. Measurements were performed on 20 mm (L)×10 mm (W)×0.06 mm (H) films from 25° C. to 550° C. using EXSTAR6000, Seiko Instruments, Inc.; under tensile loading at a heating rate of 5° C./min and frequency of 1 Hz.

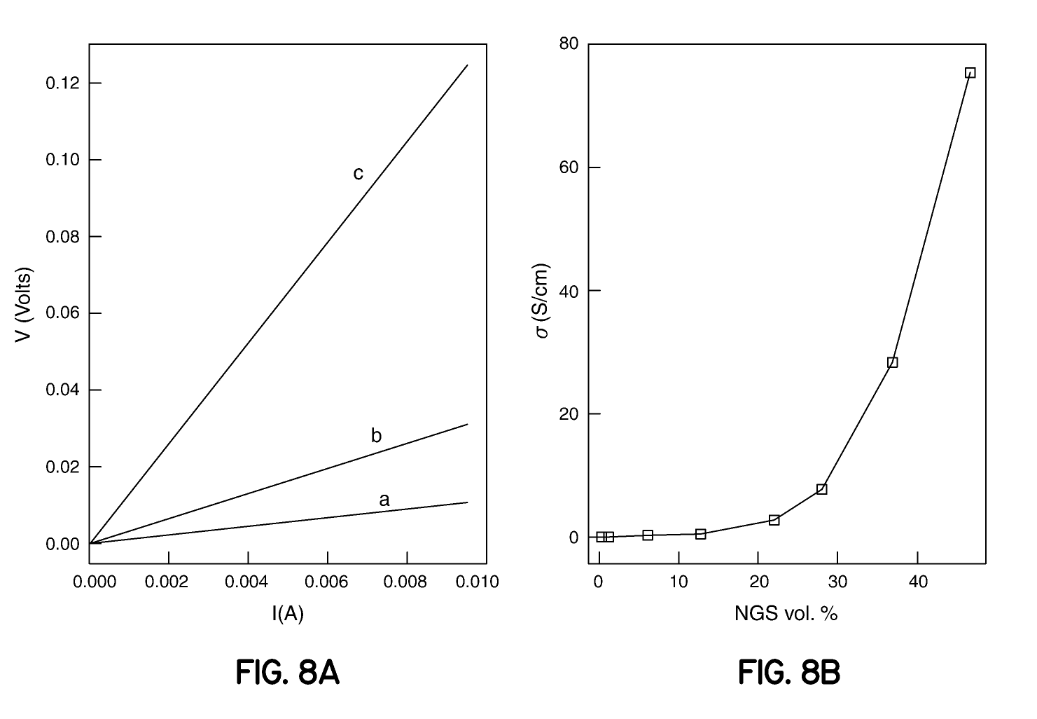

FIG. 8A shows the I-V curves of NGS/PI composite films containing 36.96, 28.10 and 22.08 vol % NGS. The corresponding plot of surface conductivity as a function of NGS loading is shown in FIG. 8B. As shown in FIG. 8B and Table 1 (below), sheet conductivity of the NGS/PI composite films increases with increasing NGS loading. At low NGS loading (e.g., ≦0.2 vol %) where a conductive network of NGS is not present, electron mobility in the NGS/PI composite is very low, therefore sheet conductivity of the composite films is also very low. A sheet conductivity of 6.71×10¹⁵ S/cm for the NGS/PI composite was recorded at 0.29 vol % NGS loading. Most polymers behave as insulators because their elections are involved in covalent bonding. Polyimide is almost a perfect insulator because its rigid heterocyclic backbone gives rise to a band structure that has a large energy gap and therefore low electrical conductivity. The addition of conductive fillers such as nano-graphene sheet particles improves the conductivity of polyimide by forming a conductive network which depends on the aspect ratio, geometry, as well as the volume fraction of the filler material. At about 1.18 vol % NGS, the conductivity of the NGS/PI composite, recorded as about 3.91×10⁷ S/cm, is quite significant compared to that at 0.29 vol % NGS loading. And despite the insulating nature of polyimide, it is believed that at about 1.18 vol % NGS loading, a dense network of nano-graphene sheets is present, which greatly improves the mobility of electrons in the NGS/PI composite.

TABLE 1
Volume percent, sheet resistance, sheet resistivity,
and sheet conductivity of NGS/PI composite film.

| Vol % | Rs(Ω sq) | Ps(Ω-cm) | σₛ (S/cm) |
|---|---|---|---|
| 46.80 | 1.102 | 1.34E+2 | 74.68 |
| 36.96 | 3.138 | 3.56E+2 | 28.10 |
| 28.10 | 12.47 | 1.30E+2 | 7.68 |
| 22.08 | 36.14 | 3.53E+1 | 2.84 |
| 12.78 | 240.58 | 1.99E+0 | 5.01E−01 |
| 6.12 | 493.19 | 3.83E+0 | 2.61E−01 |
| 1.18 | 3.55E+08 | 2.56E+6 | 3.9IE−07 |
| 0.59 | 3.55E+12 | 2.37E+10 | 4.22E−11 |
| 0.29 | 2.48E+16 | 1.49E+17 | 6.71E−15 |

Electrical percolation threshold: The electrical percolation threshold is the critical filler volume percent, Ø_{c}, at which a composite material changes from a capacitor to a conductor as a result of the formation of a conductive network of filler particles, and this conductive network greatly improves electron mobility in the composite film. Beyond the electrical percolation threshold, Ø_{c}, the conductivity of the NGS/PI composite as a function of filler loading can be modeled by the modified classical percolation theory (Equation 2) as follows:

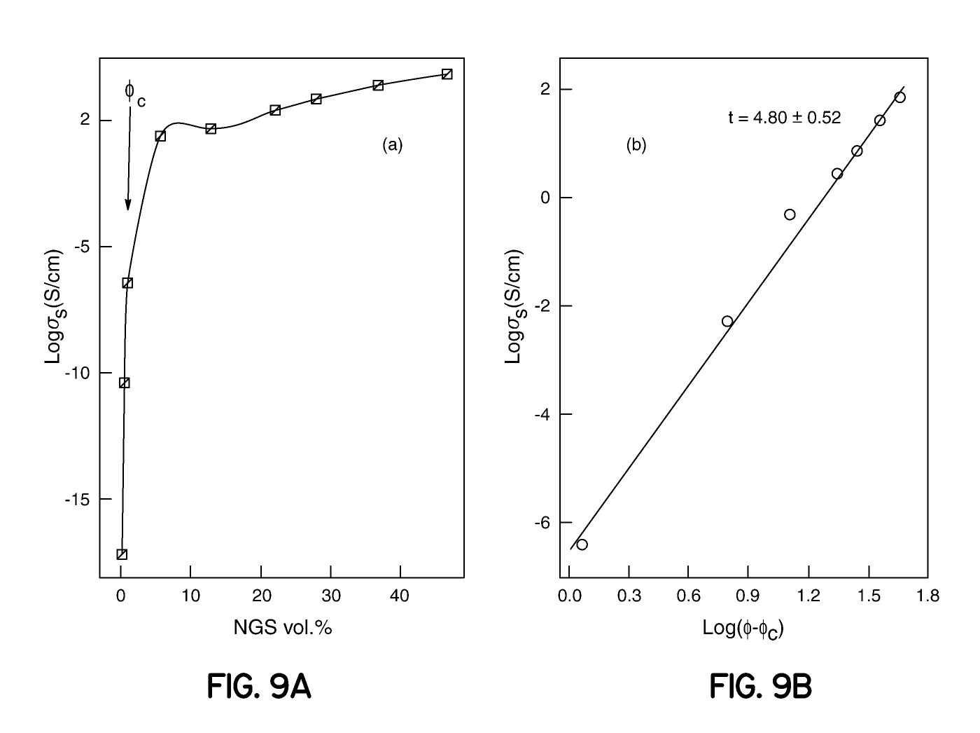

σ_{c}=σ₀(Ø−Ø_{c})ⁱ (Equation 2)

where Ø is the filler volume fraction, Ø_{c} is the percolation threshold, σ₀ is the filler conductivity, σ_{c} is the conductivity of the NGS/PI composite film and t is a critical exponent, which describes the fractal properties of the percolating mediun at large scale and close to the transition. By extrapolating conductivity to zero, as shown in FIG. 9, the percolation threshold, Ø_{c} of the NGS/PI composite was obtained to be 0.2 vol %. At 1.18 vol %, the sheet conductivity exceeds the antistatic criterion of thin films (1×10⁻⁸ S/cm) which is the target conductivity level for many composite applications. A value of 4.80±0.52 was obtained for the critical exponent, t. A critical exponent value of t=3.47±0.20 has been reported for graphene/PMMA composites and even higher values of 4.1, 4.5 and 6.27 have been reported for pulsed laser vaporization SWNT(PLV), oxidized PLV poly(m-phenylenevinylene)-co-[2,5-dioctyloxy)vinylene] (pmPV) composites, and graphite-polyethylene composites, respectively. The critical exponent, t, is a characteristic of extreme geometries (fractals) of the conducting particles and could be indicative of different electron transport behavior in the composite film. Higher values (t>2.5) of the critical exponent have been attributed to increasing tunneling barriers between the filler aggregates which would lead to low composite conductivities.

Quantum Electron Tunneling

In percolation theory the formation of an infinite percolative network through the composite material assumes that physical contact exists between the conductive aggregates, but in real composite materials, charge carriers can cross from one conductive cluster to another with no particular need for physical contact. Since the percolation theory alone cannot be sufficient to fully explain the mechanism of conductivity in the NGS/PI composite, this study used the electron tunneling theory to better explain the conductivity mechanism in the NGS/PI composite. In composite materials, electrons can flow through a sufficiently small insulating barrier due to quantum mechanical tunneling, and tunneling is therefore considered as the main transport mechanism in composite materials near the insulator-conductor transition region

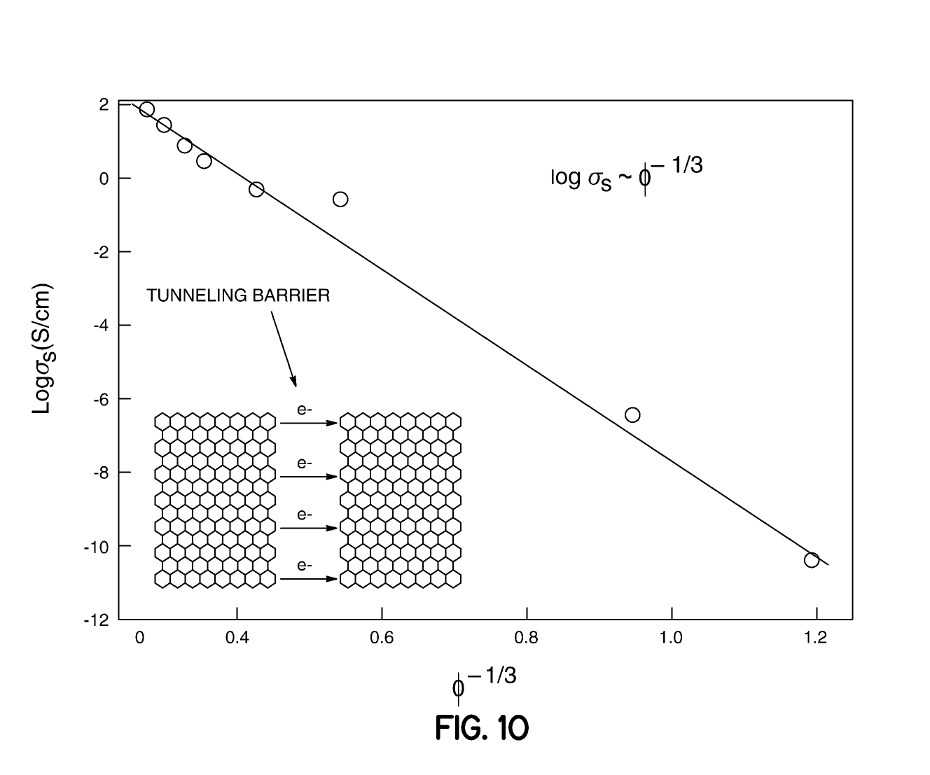

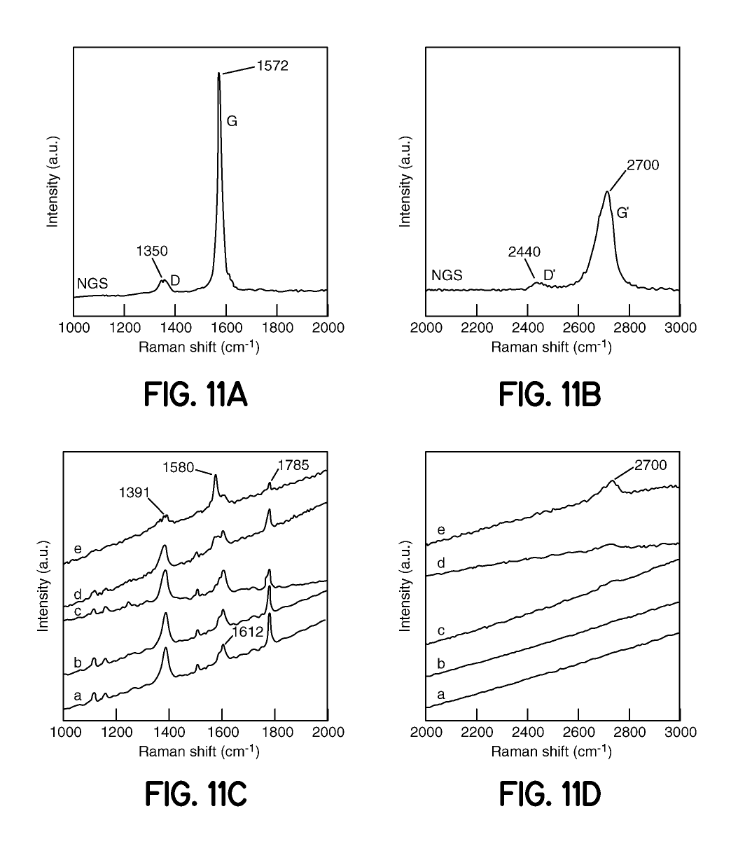

Quantum electron tunneling mechanism in the NGS/PI composite can be established using a theoretical model (log σₛ˜Ø⁻³) as shown in FIG. 10, where Ø, the filler volume fraction is obtained by using composite theory (equation 3).

Ø=(ρₘωᵣ)/(ρ_{f}ωₘ−ρₘω_{f}) (Equation 3)

And Ø is the filler volume fraction, ρₘ is the density of the matrix material, ρ_{f} is the density of the filler, ωₘ is the weight fraction of the matrix material and ω_{f} is the weight fraction of the filler. For a homogenous composite material, the composite conductivity at any given temperature can be described by the_{y} behavior of a single tunnel junction in which the tunneling barrier width is given by W∝Ø^{-1/3}. The expected linear relationship between log σₛ and Ø^{-1/3} is shown in FIG. 10, indicating that electron tunneling mechanism may be present in the NGS/PI composite. Previous researchers have reported that there is a linear relation between electrical conductivity σₛ in logarithmic scale and concentration, Ø^{-1/3}, in cases in which the electrical conductivity is limited by a tunneling barrier (W∝Ø^{-1/3}). The linear relationship between log σₛ and Ø^{-1/3} indicates that charge carriers in the NGS/PI composite can tunnel from particle-to-particle through the insulating polyimide matrix. In quantum electron tunneling, unlike in the percolation theory, there is no abrupt cut-off connection between conducting particles. And since the percolation theory trend shown in FIG. 9 does not show a sudden cut-off conductivity, we believe that quantum electron tunneling maybe the dominant mechanism in the NGS/PI composite.

Raman Spectroscopy: FIGS. 11A and 11B shows the 514 nm Raman absorbance spectrum of nano-graphene sheets (NGS). A prominent and intense Raman peak is observed at 1570 cm⁻¹ which corresponds to the G peak. A second graphitic peak is observed at about 2700 cm⁻¹, historically referred to as G′ and is the second most intense peak observed in graphite samples (FIG. 11B). The G peak, which is a signature feature of crystalline carbon (graphitic carbon), is always observed in graphite samples. The G peak is believed to be due to doubly degenerate zone center E_{2g} mode, while the G′ peak is not related to the G peak but is a result of second order zone-boundary phonons. And since zone boundary phonons do not satisfy Raman fundamental selection rule, they have are not observed in the Raman spectra of defect-free graphite. Such phonons are instead observed to occur about about 1350 cm⁻¹ (D peak) in graphene sheets and this Raman peak is attributed to in-plane defects between graphene structural units. Other researchers have also suggested that the D peak which is not observed in single layer graphene is believed to be due to second order changes in shape, width, and position for an increasing number of layers, reflecting the change in the electron bands via a double resonant Raman process. The nano-graphene sheet particles used in this study have average dimensions of 50 nm to 100 nm (thickness), which corresponds to about 50-100 sheets and the number of graphene layers in each stack is believed to be the cause of in-plane defects between graphene structural units.

The Raman spectra of neat-PI and PI-containing NGS are shown in FIG. 11C and 11D. Strong Raman absorption bands are observed at 1391 cm⁻¹ in neat-PI and NGS/PI composite containing NGS and these Raman peaks are attributed to C—N stretching in the imide ring. The intensity of the imide (C—N stretching) absorbance peak at 1391 cm⁻¹ decreases at high graphene volume fractions and is seen to overlap with the D band (1350 cm⁻¹) in graphene, which indicates an interference of the imide ring orientation in the presence of graphene. This unique interaction between graphene and polyimide is also observed in the WAXD results in which a new microstructure may have been created at a diffraction angle 2Θ of 5.65° in the thick films and 6.81° in the thin films. As is the case with graphene oxide, it is believed that the carbonyl and hydroxyl groups in polyimide and/or poly(amic)acid can distort the basal plane of the graphene layers thereby enhancing the D band. A Raman absorbance peak which is associated with C═O stretching in carbonyl group of poly(amic acid) is observed at 1615 cm⁻¹ and this peak is observed to shift to lower wavenumbers at high nano-graphene sheet particles volume fraction. A Raman shift of 32 cm⁻¹ is observed at 36.96 vol % and the shift to lower wavenumber is indicative of the emergence of the G peak in the NGS/PI composite. This phenomenon is consistent with the electrical conductivity result of the NGS/PI composite material, which increases with increasing graphene volume fraction. At higher volume fraction (V_{F}=6.18%) of graphene, the second graphitic band (G′ peak), due to second order zone—boundary phonons is observed, which is consistent with the emergence of the G peak. A Raman absorption peak is also observed at 1790 cm⁻¹ in PI NGS/PI composite and is believed to be due to C═O stretching in the imide ring.

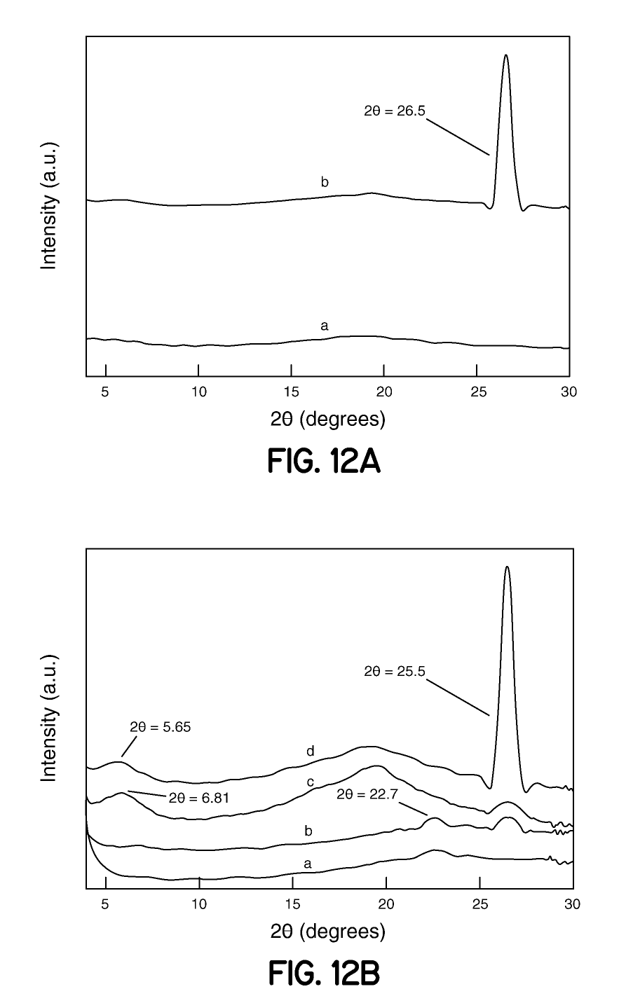

Wide Angle X-Ray Diffraction (WAXD) Analysis: FIGS. 12A and 12B shows the WAXD diffraction spectra of NGS powder, neat-PI, and NGS/PI composite in which two film sizes were studied: about 100 micron and about 400 nm. The WAXD spectrum of NGS powder ((b) in FIG. 12A) shows a sharp and strong diffraction peak at 2θ=26.5°, which corresponds to the interlayer spacing (d=3.36 Å) in graphite. The WAXD spectrum of polyimide, PI, shows a broad diffraction peak at a diffraction angle, 2θ, of 18.87° which corresponds to a d-spacing of 4.70 Å. It is noted that polyimide derived from pyromellitic dianhydride and 4,4′-oxydianiline is amorphous thermoplastic and therefore does not show any angle diffraction peaks between diffraction angles of 4° and 14°. The WAXD spectrum of the 100 micron NGS/PI composite film shows two diffraction peaks at 2θ=26.5° and 5.65° (d=15.63 Å). The graphitic diffraction peak (2θ=26.5°) decreases with decreasing graphene loading, which indicates successful dispersion of the graphene sheets in the PI matrix. The new diffraction peak at 2θ=5.65°, which only appears in the thicker (100 micron) NGS/PI composite films, is indicative of a new microstructure as a result of interaction between graphene sheets and the carbonyl group (C═O) in polyimide and/or poly(amic acid) or the hydroxyl (—OH) group in poly(amic)acid. In the thinner (400 nm) films, this peak appears at 2θ=6.81° (d=12.97 Å) and is enhanced. We believe the carbonyl and hydroxyl groups in polyimide and/or poly(amic acid) can distort the basal plane of the graphene layers as reported in graphene oxide have shown that the formation of carbonyl groups within the graphene basal plane is energetically more favorable compared to other groups such as epoxies or ethers. To our knowledge, this is the first time this peak has been observed in polymer-graphene composites. Also in the thinner (400 nm) NGS/PI composite films, the graphitic peaks are shifted to lower diffraction angles of 2θ=22.73° and 2θ=25.5°, respectively, which suggests successful dispersion.

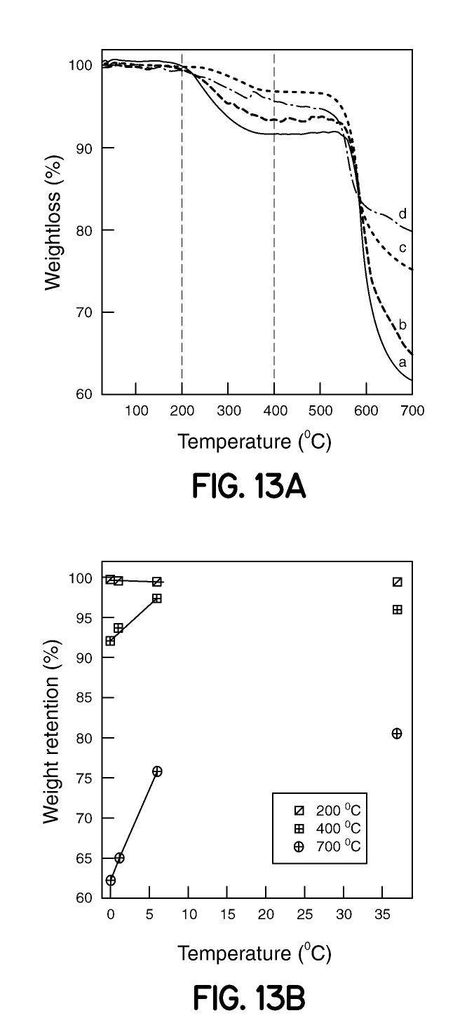

Thermal stability of NGS/PI composite films: Thermal gravimetric analysis was performed on the NGS/PI composite films where the weight loss due to the discharge of degradation products was monitored as a function of temperature as shown in FIG. 13A. Studies were performed on PI and PI-containing 1.18 vol %, 6.12 vol %, and 36.96 vol % NGS and as shown in Table 2, the thermal degradation temperature (T^{d}) increased with increased NGS volume fraction except at 36.96 vol %. Graphene has very high thermal conductivity, which increases the thermal conductivity and subsequently the thermal stability of the graphene-based composite materials. The decrease in thermal degradation temperature at 36.96 vol % is likely due to increase in the heat density of the NGS/PI composite matrix material as a result of the surrounding graphene sheets. The char retention (%) of PI and NGS/PI composite taken at 200° C., 400° C., and 700° C. was plotted as a function of NGS volume fraction as shown in FIG. 13B. At 200° C., char retention for PI and NGS/PI composite is about 99.8%, at 400° C., char retention decreases and becomes sensitive to NGS concentration and at 700° C., there is a significant decrease in char retention as well as increased sensitivity to NGS concentration in the NGS/PI composite. Char retention at 700° C. was obtained to be: 62.15, 65.03, 75.8, and 79.98% for PI and PI-containing 0, 1.18, 6.12, and 36.96 vol % NGS, respectively. The significant increase in char retention at high NGS concentration is attributed to the high thermal stability of nano-graphene sheets.

TABLE 2
Degradation temperature and weight retention
of Neat PI and NGS/PI composites.

| Vol % | 200° C. | 400° C. | 700° C. | T^{d} (° C.) |
|---|---|---|---|---|
| 36.96 | 99.50 | 96.10 | 79.98 | 589.5 |
| 6.12 | 99.55 | 97.48 | 75.84 | 604.2 |
| 1.18 | 99.60 | 93.64 | 65.03 | 605.5 |
| 0.00 | 99.80 | 92.13 | 62.15 | 561.5 |

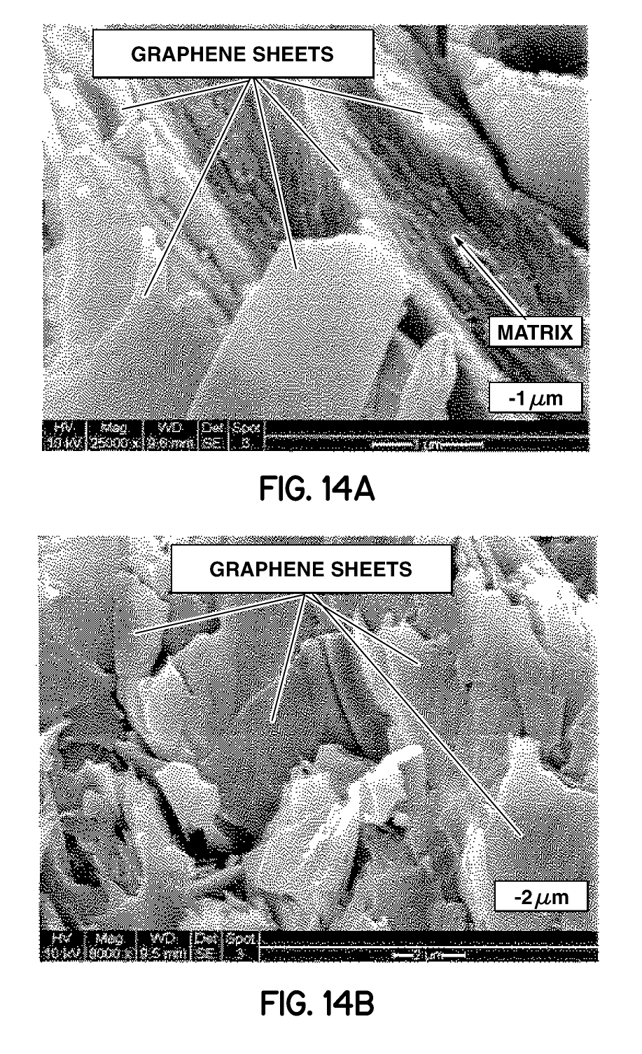

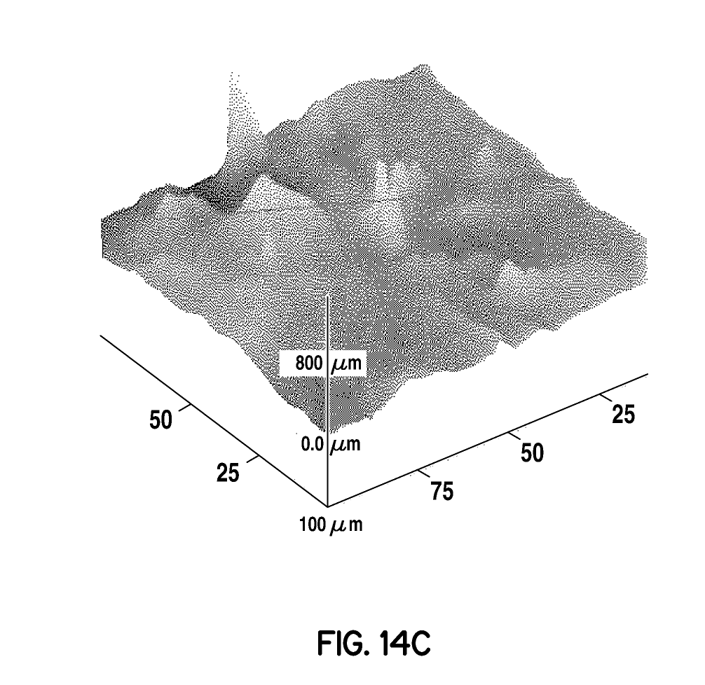

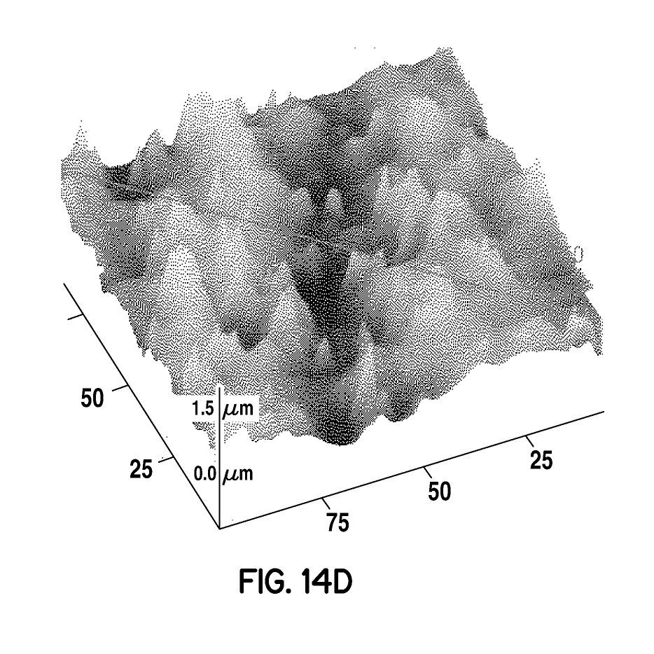

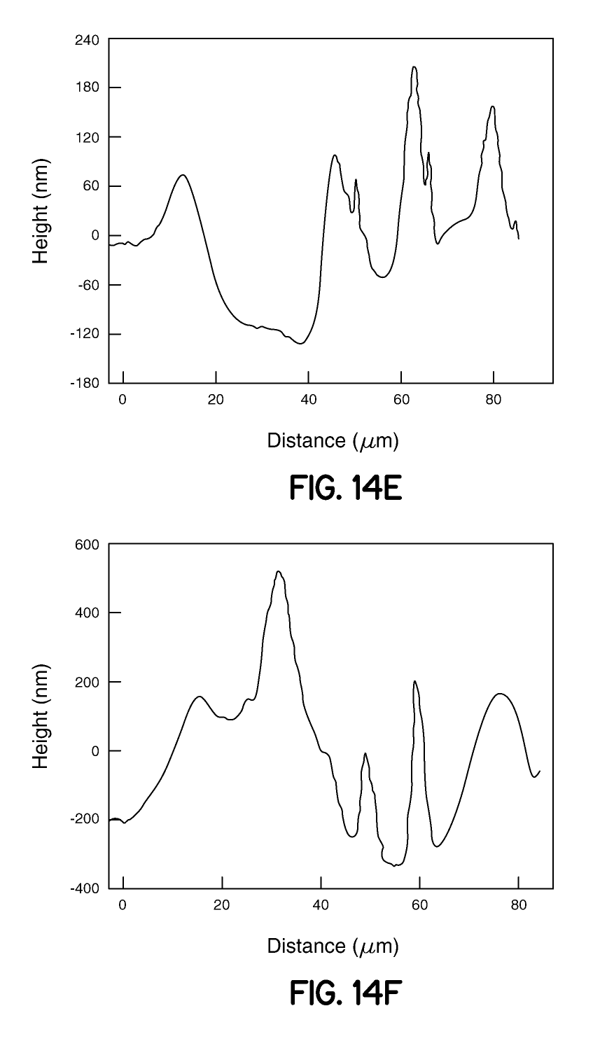

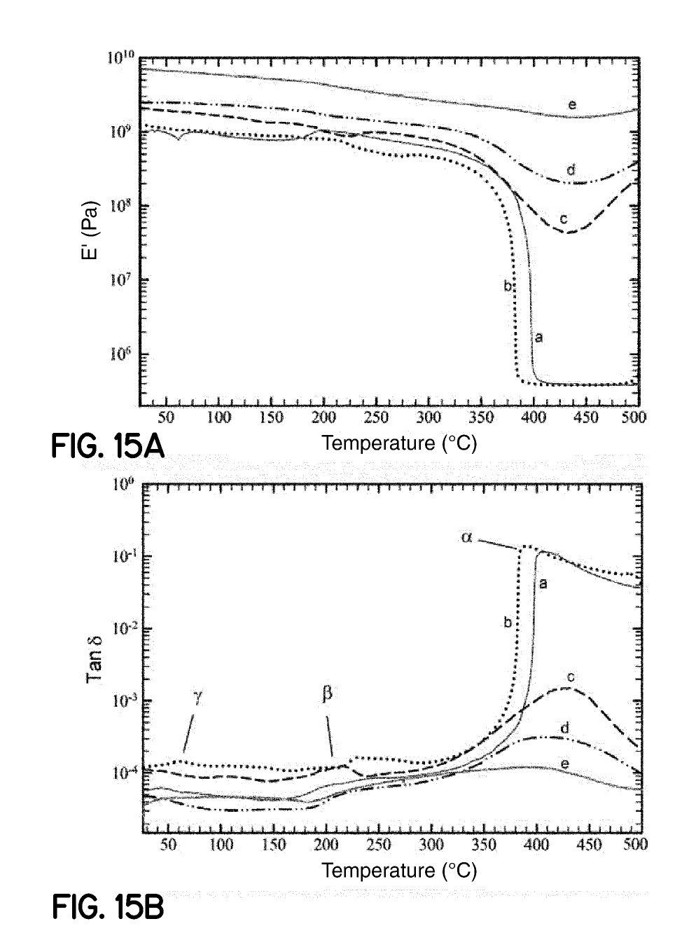

Atomic Force Microscopy (AFM) and Scanning Electron Microscopy (SEM): FIGS. 14A and 14B shows the ESEM micrographs of a cross-section of NGS/PI composite containing 6.12 vol % and 22.08 vol % NGS. NGS/PI composite generally show a sandwiched cross-sectional morphology consisting of overlapping graphene sheets as shown in FIGS. 14A and 14B. The ESEM micrographs also confirm the 2D shape of graphene and the stacking of graphene sheets in polyimide. The stacking of graphene sheets (FIGS. 14A, 14B) is attributed as the reason for the decreased flexibility of nano-graphene sheet particles in the polyimide matrix and to a greater extent; this explains the influence of graphene on polyimide properties. The distribution of nano-graphene sheet particles in the polyimide matrix has a significant influence on the modulus, Tg and damping property of the NGS/PI composite. FIGS. 15C-15F show the AFM height profile NGS/PI composite containing 1.18 vol % and 6.12 vol % of NGS, respectively. The presence of nano-graphene sheet particles and its distribution in the polyimide matrix is noticeable in FIGS. 14C-14D. The 3-D morphology (FIGS. 14C-14D) shows evidence of layer-on-layer stacking The nano-graphene sheet particles used in this study have average dimensions of 50-100 nm in thickness and about 7 microns in length, which corresponds to 50-100 sheets per stack. The AFM height profile in FIGS. 14E and 14F show hill-like features bordering each other and this is consistent with the layer-on-layer stacking of graphite sheets.

Moreso, the AFM profile shown in FIG. 14D shows evidence of overlapping of nano-graphene sheets, which is critical for electron mobility. The microstructure of the NGS/PI composite shows a uniform distribution of graphene as bright features of about 60 nm to 230 nm in height (FIG. 14C) and about 50 to 500 nm in height (FIG. 14D). The average surface roughness of NGS/PI composite containing 1.18 vol % and 6.12 vol % NGS was estimated to be about 58.7 nm and 220 nm, respectively. The large difference in surface roughness is attributed to the higher layer-on-layer stacking in 6.12 vol % NGS/PI compared to 1.18 vol % NGS/PI composite.

Conductive and highly transparent NGS/PI composite films were successfully formulated. Sheet conductivity was observed to increase with NGS loading with a value of about 74.68 S/cm recorded for 46.8 vol % NGS. An electrical percolation threshold of about 0.2 vol % was obtained for the NGS/PI composite films. The linear relationship between sheet conductivity in logarithmic scale, log σₛ and concentration, Ø^{-1/3} indicates that quantum tunneling of charge carriers through the corresponding particle-to-particle distance exists in the NGS/PI composite. The optical transparency of then NGS/PI composite varies with film thickness and this ability to tune transparency can enable NGS/PI composites to be used as saturable absorbers for high power lasers. Raman spectroscopy showed a Raman shift of 32 cm⁻¹ from 1612 cm⁻¹ to 1580 cm⁻¹ at 36.96 vol %, which indicates an increase in the G band and is consistent with electrical conductivity results. The emergence of a new WAXD peak at diffraction angle, 2θ=5.65° (thick films) and 6.81° (thin films) is believed to be due to in-plane defects between graphene structural units. NGS enhanced the thermal stability of the NGS/PI composite as evidenced by the increase in activation energy of decomposition with increasing NGS volume fraction. The decreased thermal stability at high NGS loading (V_{F}=36.96%) is attributed to increased heat density of the NGS/PI composite as at high NGS volume fraction.

It was also determined that the average number of graphene sheets (Nc) per nano-graphene sheet particles (aggregate) increases with increasing graphene loading. According to embodiments of the invention, Nc values can range from about 15 to about 100. For example, Nc values of 46 and 73 were obtained for NGS/PI composites containing 0.29 and 6.12 vol % of nano-graphene, respectively (see Table 3 below). The value of Nc, 73, at 6.12 vol % nano-graphene is greater than the 61 sheets obtained for graphene powder. The WAXD results show that improved dispersion (decreasing value of Nc) of NGS in NGS/PI composite is realized at low volume fraction of nano-graphene sheet particles. At 28.08 vol % NGS, the value of Nc is recorded to be about 83, which shows increased stacking of the graphene sheets at high volume fraction of nano-graphene sheet particles. This is consistent with the cross-sectional morphology of the NGS/PI composite depicted in the SEM images (FIGS. 14A, 14B), which shows increasing stacking of NGS with increasing NGS volume percent.

TABLE 3
Dependence of glass-transition temperature (Tg)
and glassy region storage modulus (E′) of NGS/PI
composites on the volume fraction of NGS.

| NGS (vol. %) | Tan δ area | Tg (° C.) | E′ (GPa) |
|---|---|---|---|
| 0.00 | 4.450 | 405.9 | 1.20 |
| 0.29 | 8.050 | 390.6 | 1.30 |
| 0.59 | 7.029 | 403.3 | 1.90 |
| 1.18 | 0.101 | 430.3 | 2.40 |
| 6.12 | 0.014 | 436.7 | 2.50 |
| 12.47 | 0.0075 | 437.8 | 2.92 |
| 22.08 | 0.0056 | 438.0 | 6.83 |
| 28.08 | 0.0027 | 439.1 | 7.20 |

Viscoelastic properties: The effect of temperature and composition on the viscoelastic properties of polyimide and NGS/PI composite are shown in FIGS. 15-18. The occurrence of the gamma (γ), beta (β) and alpha (α) transitions for polyimide and their corresponding temperatures, T_{γ}, T_{β} and T_{α}, of 50° C., 250° C. and 406° C., respectively, are shown in FIG. 15B. The intensity of the gamma (γ) transition is very weak and broad for both polyimide and the NGS/PI composites. The temperature for the beta (β) transition for NGS/PI composite lies between 200° C. and 300° C. and the intensity of the beta (β) transition peak is significantly enhanced at low loading of graphene most probably due to effective interfacial interaction between graphene and polyimide, which allows for molecular vibration at the interface. The α-transition occurs at about 406° C. for polyimide. The alpha (α) transition peak is much sharper and intense than those for the gamma (γ) and beta (β) secondary transitions, which are weak and broad. The intensity of the alpha (α) transition peak for the composite containing low volume fraction of nano-graphene (e.g., <0.29 vol %) is higher than that for neat polyimide matrix, but it decreases drastically at higher graphene concentration (e.g., >1.18 vol %). The reciprocal relationship between the alpha (α) transition peak intensity and the volume fraction of nano-graphene sheet particles is attributed to increased restriction of polymer chain motion due to reduction in free volume.

Size of alpha (α) transition peak: The area under the α-transition peak is related to the energy dissipated during deformation and was calculated for polyimide and NGS/PI composite by using Equation (3), and the results are shown in Table 4.

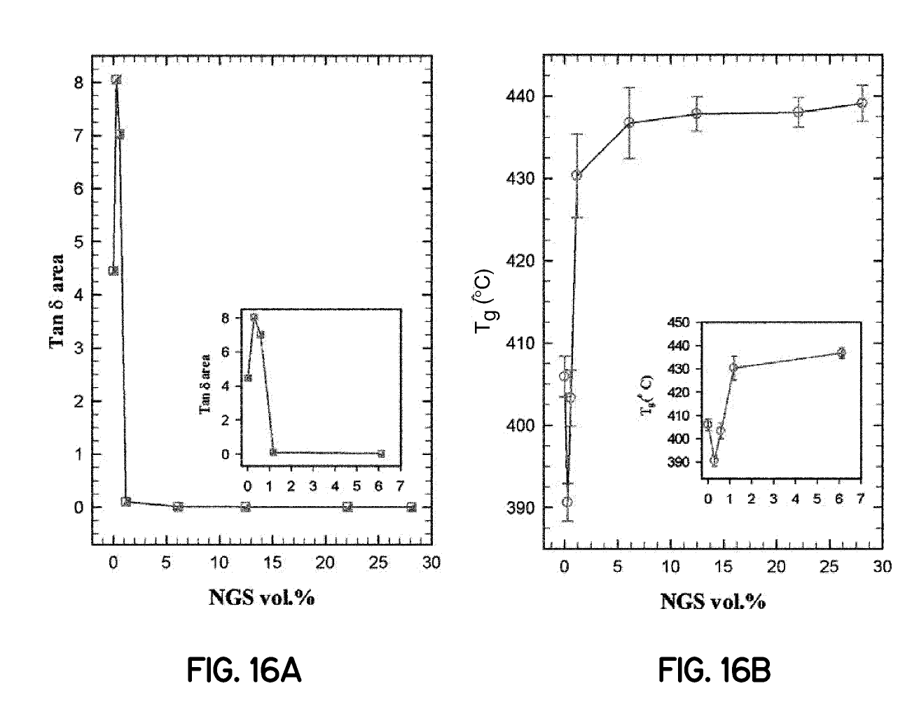

Area=∫_{T}_{₀}^{T}^{₁}(tan δ)δτ (3)

where T₀ is the reference temperature, taken to be the temperature for the onset of the glass-rubber transition (α-transition). It is noted that the value of tan δ below the glass-rubber transition region is very small and therefore neglected. Tₜ is the final temperature and is assigned a value of 500° C. The area under the tan δ curve for the α-transition is a good indicator of the total energy absorbed during deformation and is associated with polymer molecular motion and dissipation of energy (see FIG. 16A). Therefore, the area under the α-transition peak is often correlated with a material's damping ability. FIG. 16B shows the variation of α-transition peak area with nano-graphene sheet particles volume fraction. Increasing the volume fraction of nano-graphene sheet particles decreases the α-transition peak area.

TABLE 4
Full width at half maximum height (β₀₀₁), average
number of stacks per aggregate (N_{c}), d-spacing (Å), and
2 theta angle for graphene and NGS/PI composites.

| NGS (vol. %) | β₀₀₁/rad | N_{C} | d₀₀₁(A °) | 2 theta |
|---|---|---|---|---|
| 0.29 | 0.0113 | 46.32 | 3.345 | 26.63 |
| 1.18 | 0.0084 | 62.50 | 3.360 | 26.50 |
| 6.12 | 0.0072 | 72.69 | 3.362 | 26.51 |
| 28.08 | 0.0063 | 82.52 | 3.361 | 26.50 |
| NGS | 0.0086 | 60.92 | 3.356 | 26.54 |

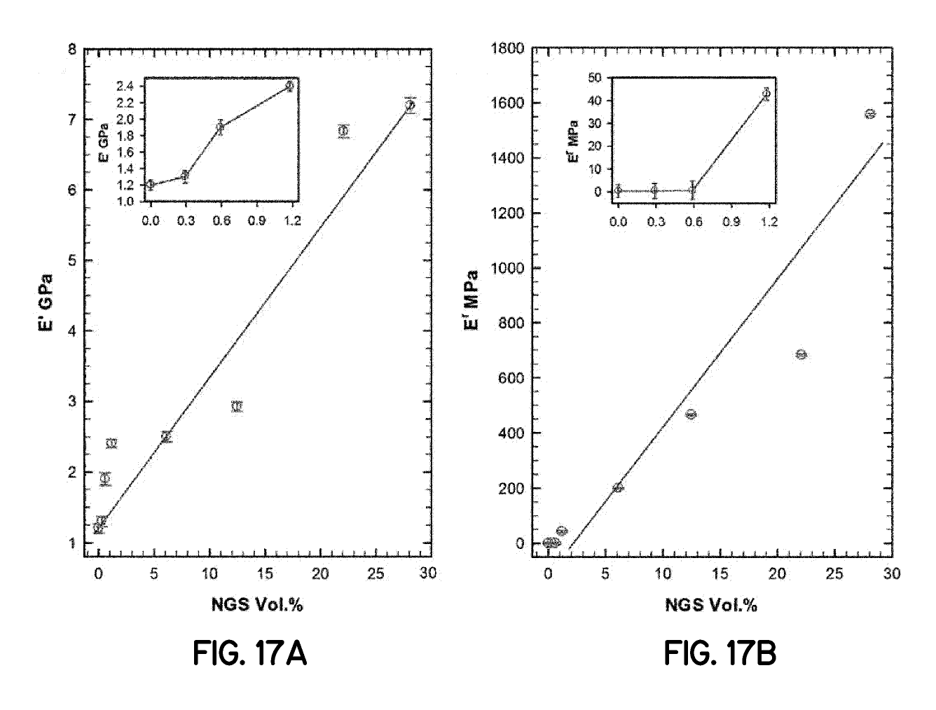

A dramatic increase in the α-transition peak area of about 80.9% was obtained for NGS/PI composite containing 0.29% of nano-graphene sheet particles ene. However, at a higher nano-graphene sheet particles volume fraction (e.g., ≧1.18 vol %), an inverse relation between the volume fraction of nano-graphene sheet particles and the alpha (α) transition peak area occurs (FIG. 17A). A drastic decrease in the α-transition peak area of about 97.7% was obtained for NGS/PI composite containing 1.18 vol % of graphene. The unusual damping behavior of NGS/PI composites originates from the 2D structure and high aspect ratio of graphene. The nano-graphene sheet particles used in exemplary embodiments of the present invention have average dimensions of about 50 nm to about 100 nm (width) and 7 microns (length). The high aspect ratio and surface area of graphene provides a high interfacial area in the NGS/PI composite. The close proximity between the graphene sheets can lead to high frictional energy dissipation as they rub against each other. At lower concentration, graphene enhances the polyimide chains mobility thereby improving the damping ability of the polyimide composite accordingly. The 2D geometry and high aspect ratio of graphene may have contributed to the reciprocal relationship between the volume fraction of nano-graphene sheet particles and a-transition peak area. At low nano-graphene sheet particles volume fraction, the large interfacial area and frictional energy dissipation is responsible for the high a-transition peak area. At higher nano-graphene sheet particles concentrations (e.g., ≧1.18%), the rigid nano-graphene sheet particles restrict polyimide chain motion, resulting in a drastic decrease in the α-transition peak area and a concomitant increase in the glass-rubber transition temperature (Tg).

Glass-transition temperature (Tg): The glass-transition temperature (Tg) is the temperature at which a polymer changes from glassy to rubbery behavior. It is the temperature corresponding to the peak of the α-transition in the tan δ versus temperature curve for polyimide and NGS/PI composite, respectively. The Tg of NGS/PI composite (FIG. 15B and 16A) increases with increasing nano-graphene sheet particles volume fraction except at very low nano-graphene sheet particles volume fraction (e.g., ˜0.29 vol %) at which a slight decrease in the Tg is observed. A remarkably high Tg of about 430.3±5.1° C. is obtained for NGS/PI composite containing 1.18 vol % of nano-graphene sheet particles, which corresponds to an enhancement of Tg of about 6% over that for the polyimide matrix.

Storage modulus (E′): In a viscoelastic material, the storage modulus (E′) is the real part of complex modulus of a material subjected to sinusoidal deformation. The dependence of the storage modulus (E′) of NGS/PI composite on temperature is shown in FIG. 15A. The storage modulus of the NGS/PI composite remained constant at 1-3 GPa below 350° C. after which it decreased, initially gradual and finally sharply as shown in FIG. 15A. FIGS. 17A and 17B show that the storage modulus (E′) of NGS/PI composite increases with increasing volume fraction of nano-graphene sheet particles. A storage modulus (E′) of 2412±44.3 MPa is obtained for NGS/PI composite containing 6.18 vol % of nano-graphene sheet particles. This represents about 108% increase in the storage modulus of polyimide matrix.

A modified Halpin-Tsai micromechanical model (Equation 4) can be used to calculate the modulus enhancement E′ₛ, for NGS/PI composite containing randomly dispersed nano-graphene sheet particles.

$$\begin{matrix}{E}_{s}^{′} = \frac{{E}_{c}^{′}}{{E}_{m}^{′}} = \{ [ \frac{3}{8} \frac{1 + 2 α {η}_{L} {V}_{NGS}}{1 - {η}_{1} {V}_{NGS}} \frac{5}{8} \frac{1 + 2 {η}_{T} {V}_{NGS}}{1 - {η}_{T} {V}_{NGS}} ] {E}_{m}^{′} \} / {E}_{m}^{′} & ( 4 ) \\ {η}_{L} = \frac{( {E}_{NGS}^{′} / {E}_{m}^{′} - 1 )}{( {E}_{NGS}^{′} / {E}_{m}^{′} - 1 ) + 2 {α}_{NGS}} & ( 5 ) \\ {η}_{T} = \frac{{E}_{NGS}^{′} / {E}_{m}^{′} - 1}{{E}_{NGS}^{′} / {E}_{m}^{′} + 2} & ( 6 )\end{matrix}$$

where n_{L} and n_{T} are defined in Equations 5 and 6, respectively, and E′_{c}, E′ₘ, and E′ₘ are the storage moduli of the composite, nano-graphene sheet particles, and polyimide, respectively. A_{NGS} and V_{NGS} are the nano-graphene sheet particle aspect ratio and volume fraction, respectively. The average width and length of the nano-graphene sheet particles were taken to be about 50 nm and 7 microns, respectively.

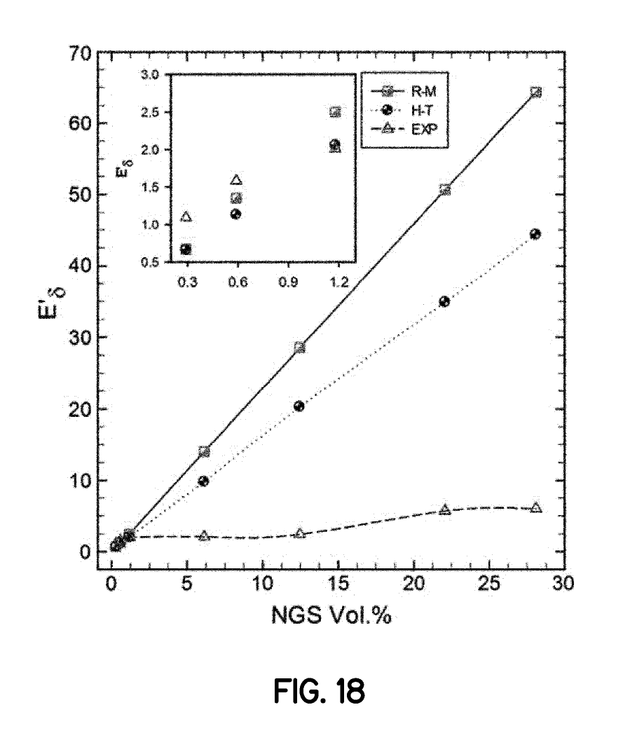

FIG. 18 shows the variation of the modulus enhancement of NGS/PI composite with volume fraction of nano-graphene sheet particles calculated using experimental data (EXP), Halpin-Tsai (H-T) and Rule of Mixture (R-M) equation, respectively. The modulus enhancement, in the glassy region (T<400° C.), for the composites increases sharply with nano-graphene sheet particles concentration at low volume fraction of nano-graphene sheet particles (e.g., ≦1.18 vol %) followed by a gradual increase at moderate volume fraction of nano-graphene sheet particles (6.12 vol %≦V_{F}>1.18 vol %). The prediction of the dependence of composite modulus enhancement on the volume fraction of graphene, E′ₛ, by the Halpin-Tsai micromechanical model (Equation 7) is shown in FIG. 18. The elastic modulus of a single sheet of graphene is assumed to be 1.02 TPa, however since the nano-graphene sheet particles used in this study contained between 50 and 100 sheets, a more conservative value close to that of graphite fiber (390 GPa) was used. The dependence of E′ₛ on nano-graphene sheet particles volume fraction was also determined by using a modified rule of mixture equation (Equation. 7) for randomly dispersed discontinuous nano-graphene sheet particles.

$${E}_{s}^{′} = \frac{{E}_{c}^{′}}{{E}_{m}^{′}} = \frac{{E}_{NGS}^{′}}{{E}_{m}^{′}} ( 1 - \frac{{α}_{c}}{{α}_{NGS}} ) φ + ( 1 - φ ) \qquad ( 7 )$$

where E′_{c}, E′ₘ, and E′_{NGS} are the elastic modulus of NGS/PI composite, matrix, and nano-graphene sheet particle filler, respectively; and Ø is the filler volume fraction. α_{c} and α_{NGS} are the critical aspect ratio and aspect ratio of graphene, respectively. As shown in FIG. 18, the modulus enhancement obtained by using the Halpin-Tsai equation, the rule of mixture and the experimental data are in a close agreement at low volume percent of graphene (e.g., ≦1.18). Above nano-graphene sheet particles volume fraction of 1.18%, the prediction of the micromechanical equations starts to deviate from the experimentally determined values. The experimental results deviate from the theoretical values at higher filler loading because of the non-uniformity in length and thickness of the filler, non-uniform dispersion of fillers, imperfect bonding between the filler and matrix, particle-particle interaction and filler agglomeration. The rule of mixture equation overestimates the modulus enhancement of NGS/PI composite by assuming uniform alignment of the fillers. It also assumes that the fillers are long and continuous (α>>1).

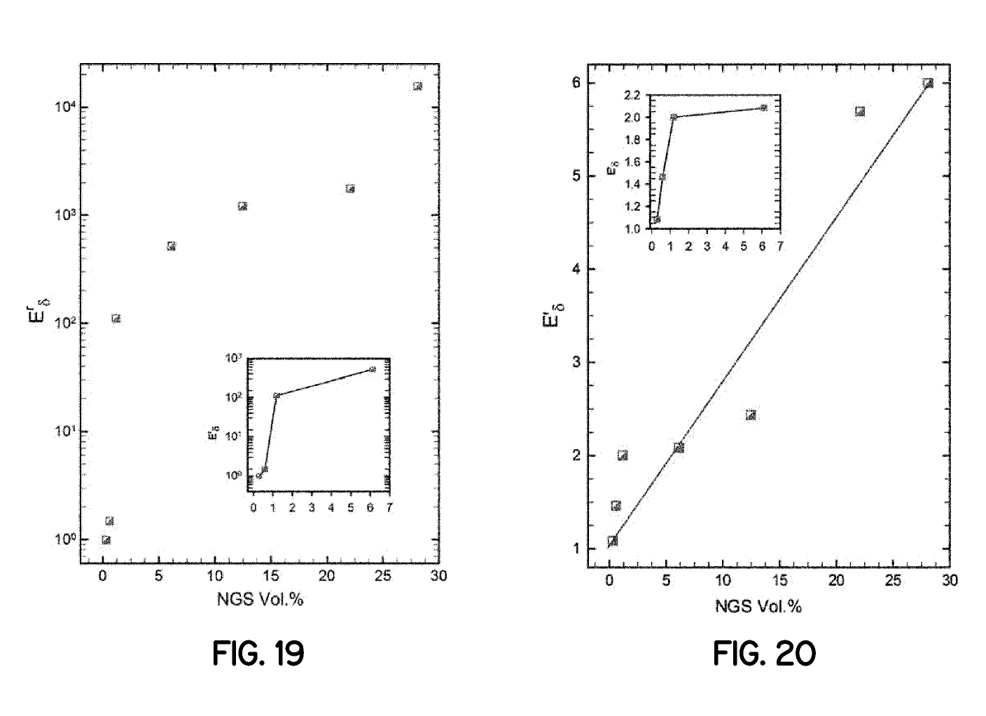

Rubbery plateau modulus: The third region of the viscoelastic behavior of a linear amorphous polymer is the rubbery plateau region. The rubbery plateau region is characterized by a rubber-like softening and reduction in the modulus of about 1 kPa (E˜1 MPa). The rigidity of the rubbery plateau region can increase significantly with increasing molecular weight and crystallinity due to increased amount of entanglements and physical cross-linking The variation of rubbery plateau modulus with NGS volume percent (FIG. 19) shows a gradual increase in modulus, then a sharp increase at about 1.18 vol % NGS. The dependence of modulus enhancement of the NGS/PI composite on the volume fraction of nano-graphene sheet particles was determined below and above the glass-rubber transition temperature (Tg). A remarkable increase in modulus enhancement was observed for the composites in the rubbery plateau region (FIG. 19) while only a slight increase in modulus enhancement occurred in the glassy region (FIG. 20). For NGS/PI composite containing about 1.18 vol % of nano-graphene sheet particles, the modulus enhancement in the rubbery plateau region is about 11,000% compared to 108% increase shown in the glassy region. Increasing the volume fraction of nano-graphene sheet particles to 6.12 vol % and 28.08 vol % increases modulus enhancement by a factor of about 5 and 36, corresponding to a 5.2×10⁴ and 4.0×10⁵% increase in the rubbery plateau region, respectively, relative to about 108% and 500% increase obtained in the glassy region. The remarkable increase in modulus enhancement above Tg is believed to be due to the exceptional rigidity of nano-graphene sheet particles, which causes a sharp disparity between the elastic moduli of the constituents. The ratio of the elastic modulus of nano-graphene sheet particles to polyimide elastic modulus is about 8.5×10⁴ below Tg (T<Tg; E_{F}/E_{M} 8.5×10⁴) but it increases dramatically above the Tg (T>Tg; E_{C}/E_{M} 2.64×10⁹). As the polyimide matrix softens above Tg, the stiff and high aspect ratio nano-graphene sheet particles restrain the polymer chain motion, resulting in a significant increase in the composite modulus.

Based on the foregoing properties of the nano-graphene sheet particles filled polyimide composites discussed above, these composites are amenable for a multitude of applications, such as batteries, capacitors, fuel cell components, solar cell components, and display screens to name a few. For example, a flexible solar panel can incorporate a layer of the nano-graphene sheet particle filled polyimide composite film; a display screen can incorporate a layer of the nano-graphene sheet particle filled polyimide composite film; an energy storage device, such as a battery or a capacitor can incorporate a layer of the nano-graphene sheet particle filled polyimide composite film; or a fuel cell component such as a fuel cell membrane or membrane electrode assembly can incorporate a layer of the nano-graphene sheet particle filled polyimide composite film.

While the present invention has been illustrated by description of various embodiments and while those embodiments have been described in considerable detail, those skilled in the art will readily appreciate that many modifications are possible in the exemplary embodiments without materially departing from the novel teachings and advantages of this invention. The invention in its broader aspects is therefore not limited to the specific details and illustrative examples shown and described. Accordingly, departures may be made from such details without departing from the scope of the present invention.

What is claimed is:

1. A composite material comprising a dispersion of nano-graphene sheet particles in a polyimide matrix.

2. The composite material of claim 1, wherein the nano-graphene sheet particles are present in an amount in a range from about 0.1 wt % to about 150 wt % based on the weight of polyimide.

3. The composite material of claim 1, wherein an average width of the nano-graphene sheet particles is in a range from about 50 nm to about 100 nm.

4. The composite material of claim 1, wherein the polyimide matrix is derived from a reaction product of a diamine compound and a dianhydride compound.

5. The composite material of claim 4, wherein the diamine compound is an aromatic diamine compound.

6. The composite material of claim 5, wherein the aromatic diamine compound is 4,4′-oxydianiline.

7. The composite material of claim 4, wherein the dianhydride compound is pyromellitic dianhydride.

8. The composite material of claim 1, wherein the material is characterized as having a wide angle x-ray diffraction (WAXD) peak at diffraction angle 2θ in a range from about 5° to about 7°, as measured using a Cu—K radiation source at a wavelength of 1.54 Å.

9. A flexible solar panel incorporating a layer of the composite material of claim 1.

10. A display screen incorporating the composite material of claim 1.

11. An energy storage device incorporating the composite material of claim 1.

12. A fuel cell membrane incorporating the composite material of claim 1.

13. A method of forming a nano-graphene sheet particle filled polyimide film, comprising:
1) forming a solution of nano-graphene sheet particles and poly(amic acid);
2) casting the solution on a substrate to form a film; and
3) imidizing the film.

14. The method of claim 13, wherein the forming the solution of nano-graphene sheet particles and poly(amic acid) comprises:
a) dispersing nanographene sheet particles in a volume of a polar, aprotic organic solvent comprising a diamine compound to form a dispersed nano-graphene sheet particle mixture; and
b) adding a dianhydride compound to the dispersed nano-graphene sheet particle mixture thereby affecting an in situ polymerization of the diamine compound and the dianhydride compound.

15. The method of claim 14, wherein adding the dianhydride compound to the dispersed nano-graphene sheet particle mixture is performed at a mixture temperature in a range from about −10° C. to about 60° C.

16. The method of claim 14, wherein the polar, aprotic organic solvent is selected from the group consisting of tetrahydrofuran, dimethyl formamide, dimethylacetamide, N-methylpyrrolidinone, and dimethylsulfoxide.

17. The method of claim 14, wherein the polar, aprotic organic solvent is N-methylpyrrolidinone.

18. The method of claim 13, wherein imidizing the film comprises:
c) heating the film in the presence of a vacuum at a first temperature in a range from about 90° C. to about 130° C. for a first duration; and
d) heating the film at a second temperature in a range from about 130° C. to about 250° C. for a second duration.

19. The method of claim 13, wherein the first duration is at least about 10 minutes, and wherein the second duration is at least about 5 minutes.

20. The method of claim 14, wherein dispersing nanographene sheet particles in a volume of a polar, aprotic organic solvent, comprises:
e) forming a solution of the diamine compound in the polar, aprotic organic solvent;
f) adding nanographene sheet particles to the solution of the diamine compound in the polar, aprotic organic solvent, wherein the particles have an average width in a range from about 50 nm to about 100 nm; and
g) agitating the mixture of step f) under shearing and/or ultrasonic conditions prior to adding the dianhydride compound to the dispersed nano-graphene sheet particle mixture.

21. A nano-graphene sheet particle filled polyimide film, prepared by a method comprising:
1) forming a solution of nano-graphene sheet particles and poly(amic acid);
2) casting the solution on a substrate to form a film; and
3) imidizing the film.
